(19) United States
(12) Patent Application Publication
(10) Pub. No.: US 2024/0205925 A1
(43) Pub. Date: Jun. 20, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/287,264

(22) PCT Filed: Mar. 29, 2022
(86) PCT No.: PCT/JP2022/015533

§ 371 Date: Oct. 17, 2023

(30) Foreign Application Priority Data
Apr. 19, 2021 (JP) 2021-070114

(51) Int. Cl. H04W 72/23; H04L 1/08; H04W 72/0446; H04W 72/563

(52) U.S. Cl. CPC H04W 72/23; H04L 1/08; H04W 72/563; H04W 72/0446

(57) ABSTRACT

A terminal according to an aspect of the present disclosure includes: a control section that determines a plurality of targets to be monitored from a plurality of candidates that are any of a search space set, a physical downlink control channel (PDCCH) candidate, and a control resource set; and a reception section that monitors the plurality of targets, in which the control section preferentially includes, in the plurality of targets, a first candidate having a linkage with another candidate among the plurality of candidates and a second candidate corresponding to a common search space set. According to an aspect of the present disclosure, the PDCCH candidate/SS set/CORESET to be monitored can be appropriately determined.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). Furthermore, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+(plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In order to improve reliability in a future radio communication system, repetition of a physical downlink control channel (PDCCH) has been studied.

However, for the limit (maximum number), it is not clear how the monitored PDCCH candidate/SS set/CORESET is determined among the PDCCH candidates/SS sets/CORESETs for a plurality of repetitions. If the PDCCH candidate/SS set/CORESET to be monitored is not appropriately determined, there is a risk of causing a decrease in communication quality, a decrease in communication throughput, and the like.

Therefore, an object of the present disclosure is to provide a terminal, a radio communication method, and a base station that appropriately determine a PDCCH candidate/SS set/CORESET to be monitored.

### Solution to Problem

A terminal according to an aspect of the present disclosure includes: a control section that determines a plurality of targets to be monitored from a plurality of candidates that are any of a search space set, a physical downlink control channel (PDCCH) candidate, and a control resource set; and a reception section that monitors the plurality of targets, in which the control section preferentially includes, in the plurality of targets, a first candidate having a linkage with another candidate among the plurality of candidates and a second candidate corresponding to a common search space set.

### Advantageous Effects of Invention

According to an aspect of the present disclosure, the PDCCH candidate/SS set/CORESET to be monitored can be appropriately determined.

### BRIEF DESCRIPTION OF DRAWINGS

FIGS. 1A and 1B are diagrams illustrating an example of a maximum number of PDCCH candidates to be monitored.

FIGS. 2A and 2B are diagrams illustrating an example of a maximum number of non-overlapped CCEs.

FIGS. 3A and 3B are diagrams illustrating an example of a first embodiment.

FIGS. 4A and 4B are diagrams illustrating an example of a second embodiment.

FIGS. 5A and 5B are diagrams illustrating an example of a third embodiment.

FIG. 6 is a diagram illustrating an example of prioritized CORESET and another CORESET to be monitored simultaneously in Embodiment 1.1.1.

FIG. 7 is a diagram illustrating an example of prioritized CORESET according to Embodiment 1.1.2.1.

FIG. 8 is a diagram illustrating an example of prioritized CORESET according to Embodiment 1.1.2.1.

FIG. 9 is a diagram illustrating an example of prioritized CORESET according to Embodiment 1.1.2.1.

FIG. 10 is a diagram illustrating an example of prioritized CORESET according to Embodiment 1.1.2.2.

FIG. 11 is a diagram illustrating an example of prioritized CORESET and another CORESET to be monitored simultaneously in Embodiment 1.1.2.

FIG. 12 is a diagram illustrating an example of prioritized CORESET and another CORESET to be monitored simultaneously in Embodiment 1.1.2.

FIG. 13 is a diagram illustrating an example of prioritized CORESET and another CORESET to be monitored simultaneously in Embodiment 1.2.

FIG. 14 is a diagram illustrating an example of prioritized CORESET and another CORESET to be monitored simultaneously in Embodiment 2.1.1.

FIG. 15 is a diagram illustrating an example of prioritized CORESET according to Embodiment 2.1.2.1.

FIG. 16 is a diagram illustrating an example of prioritized CORESET according to Embodiment 2.1.2.2.

FIG. 17 is a diagram illustrating an example of prioritized CORESET and another CORESET to be monitored simultaneously in Embodiment 2.1.2.

FIG. 18 is a diagram illustrating an example of prioritized CORESET and another CORESET to be monitored simultaneously in Embodiment 2.2.

FIG. 19 is a diagram illustrating an example of a schematic configuration of a radio communication system according to one embodiment.

FIG. 20 is a diagram illustrating an example of a configuration of a base station according to one embodiment.

FIG. 21 is a diagram illustrating an example of a configuration of a user terminal according to one embodiment.

FIG. 22 is a diagram illustrating an example of a hardware configuration of the base station and the user terminal according to one embodiment.

### DESCRIPTION OF EMBODIMENTS

### (TCI, Spatial Relation, and QCL)

In NR, it has been studied to control reception processing (for example, at least one of reception, demapping, demodulation, and decoding) and transmission processing (for example, at least one of transmission, mapping, precoding, modulation, and coding) in UE of at least one of a signal and a channel (expressed as a signal/channel) based on a transmission configuration indication state (TCI state).

The TCI state may represent what is applied to a downlink signal/channel. One corresponding to the TCI state applied to an uplink signal/channel may be expressed as a spatial relation.

The TCI state is information regarding a quasi-co-location (QCL) of the signal/channel, and may also be referred to as, for example, a spatial Rx parameter, spatial relation information, or the like. The TCI state may be configured in the UE for each channel or each signal.

The QCL is an indicator indicating a statistical property of a signal/channel. For example, a case where one signal/channel and another signal/channel have a QCL relation may mean that it is possible to assume that at least one of Doppler shift, Doppler spread, an average delay, a delay spread, and a spatial parameter (for example, a spatial Rx parameter) is identical (in QCL with respect to at least one of these) between the plurality of different signals/channels.

Note that the spatial Rx parameter may correspond to a reception beam of the UE (for example, a reception analog beam), and the beam may be specified based on spatial QCL. The QCL (or at least one element of the QCL) in the present disclosure may be replaced with spatial QCL (sQCL).

A plurality of types of QCL (QCL types) may be defined. For example, four QCL types A to D with different parameters (or parameter sets) that can be assumed to be identical may be provided. These parameters (which may be referred to as QCL parameters) are as follows:
QCL type A (QCL-A): Doppler shift, Doppler spread, average delay, and delay spread;
QCL type B (QCL-B): Doppler shift and Doppler spread;
QCL type C (QCL-C): Doppler shift and average delay; and
QCL type D (QCL-D): spatial Rx parameter.

It may be referred to as a QCL assumption for the UE to assume that a certain control resource set (CORESET), channel, or reference signal has a specific QCL (for example, QCL type D) relation with another CORESET, channel, or reference signal.

The UE may determine at least one of a transmission beam (Tx beam) and a reception beam (Rx beam) of a signal/channel based on a TCI state of the signal/channel or the QCL assumption.

The TCI state may be, for example, information regarding the QCL of a target channel (in other words, a reference signal (RS) for the channel) and another signal (for example, another RS). The TCI state may be configured (given in instruction) by higher layer signaling, physical layer signaling, or a combination thereof.

Note that the channel/signal to which the TCI state is applied may be referred to as a target channel/reference signal (target channel/RS), simply a target, or the like, and the other signal may be referred to as a reference reference signal (reference RS), a source RS (source RS), simply a reference, or the like.

The channel for which the TCI state or the spatial relationship is configured (specified) may be, for example, at least one of a downlink shared channel (physical downlink shared channel (PDSCH)), a downlink control channel (physical downlink control channel (PDCCH)), an uplink shared channel (physical uplink shared channel (PUSCH)), and an uplink control channel (physical uplink control channel (PUCCH)).

Furthermore, the RS having the QCL relationship with the channel may be, for example, at least one of a synchronization signal block (SSB), a channel state information reference signal (CSI-RS), a measurement reference signal (sounding reference signal (SRS)), a tracking CSI-RS (also referred to as tracking reference signal (TRS)), a QCL detection reference signal (also referred to as QRS), a demodulation reference signal (DMRS), and the like.

The SSB is a signal block including at least one of a primary synchronization signal (PSS), a secondary synchronization signal (SSS), and a broadcast channel (physical broadcast channel (PBCH)). The SSB may be referred to as an SS/PBCH block.

An RS of QCL type X in a TCI state may mean an RS in a QCL type X relation with (DMRS of) a certain channel/signal, and this RS may be referred to as a QCL source of QCL type X in the TCI state.

### (Multiple Channel/signal Collision)

In the previous Rel. 15/16 NR specification, the UE can only receive, detect or monitor channels/signals of the same QCL type D at the same time, but cannot receive, detect or monitor a plurality of channels/signals of different QCL type D at the same time. Therefore, in order to ensure that a plurality of channels/signals corresponds to the same QCL type D in a case where the plurality of channels/signals collides (in other words, are transmitted/received at overlapping times), or to avoid such a case, the following constraint (may be referred to as a priority rule, a QCL application rule, or the like.) is defined in the Rel. 15/16 NR specification.

Note that, in the present disclosure, collision of the plurality of channels/signals may mean that reception (or transmission) of the plurality of channels/signals of different QCL types D in the same time resource (period) is scheduled (or configured) (QCL type D collision).

Furthermore, in the present disclosure, the fact that (the reference RS of) the QCL type D of a certain channel/signal is different from (the reference RS of) the QCL type D of another channel/signal may mean that a beam used for communication of the certain channel/signal is different from a beam used for communication of the other channel/signal. In the present disclosure, the fact that (the reference RS of) the QCL type D of a certain channel/signal is different from (the reference RS of) the QCL type D of another channel/signal may be expressed such that the certain channel/signal has a different QCL type D than the other channel/signal, their QCL type D characteristics are different, the “QCL type D” is different, and so on.

### <PDCCH VS. PDCCH>

In the case that the UE is configured to perform a single cell operation or an operation of the carrier aggregation in the same frequency band, and in a plurality of CORESETs having the same or different QCL type D characteristics in the active DL BWPs of one or more cells, when PDCCH candidates are monitored in overlapping monitoring opportunities, a PDCCH in only a certain CORESET and a CORESET having the same QCL type D characteristics as the CORESET among the plurality of CORESETs is monitored.

This “certain CORESET” corresponds to a CSS set with the smallest index in a cell with the smallest index, if any, including a common search space (CSS) set, otherwise corresponds to a UE-specific search space (USS) set with the smallest index in a cell with the smallest index. The smallest USS set index is determined across all USS sets with at least one PDCCH candidate in overlapping PDCCH monitoring opportunities.

In short, when the UE monitors PDCCH candidates in the overlapping monitoring opportunities, the CSS set is preferentially monitored over the USS set, and between SS sets of the same type (CSS or USS), the CORESET to be monitored is determined according to a priority rule that the one with the smaller index (that is, the one with the smaller cell index, and if the cell indices are the same, the one with the smaller SS set index) is preferentially monitored.

Note that the SS set index may correspond to a value set by an RRC parameter SearchSpaceId for identifying a search space. Note that, in the present disclosure, the CSS set index may mean an SS set index for an SS set whose search space type (RRC parameter “searchSpaceType”) indicates CSS. Furthermore, in the present disclosure, the USS set index may mean an SS set index for an SS set whose search space type (RRC parameter “searchSpaceType”) indicates USS.

### (Multi-TRPs)

In NR, studies are underway to allow one or more transmission/reception points (TRPs) (multi-TRPs (MTRPs)) to perform DL transmission to the UE by using one or more panels (multi-panels). Furthermore, studies are underway to allow the UE to perform UL transmission to one or more TRPs by using one or more panels.

Note that the plurality of TRPs may correspond to the same cell identifier (ID), or may correspond to different cell IDs. The cell ID may be a physical cell ID or a virtual cell ID.

The multiple TRPs (for example, TRPs #1 and #2) are connected by an ideal/non-ideal backhaul, and information, data, and the like may be exchanged. A different codeword (CW) and a different layer may be transmitted from each TRP of the multi-TRPs. Non-coherent joint transmission (NCJT) may be used as one form of multi-TRP transmission.

In the NCJT, for example, the TRP #1 performs modulation mapping and layer mapping on a first codeword, performs first precoding in a first number of layers (for example, two layers), and transmits a first PDSCH. Furthermore, the TRP #2 performs modulation mapping and layer mapping on a second codeword, performs second precoding in a second number of layers (for example, two layers), and transmits a second PDSCH.

Note that a plurality of PDSCHs (multi-PDSCHs) subjected to the NCJT may be defined as partially or completely overlapping with respect to at least one of a time domain or a frequency domain. That is, the first PDSCH from a first TRP and the second PDSCH of a second TRP may overlap at least one of time resources or frequency resources.

The first PDSCH and the second PDSCH may be assumed not to be in quasi-co-located (QCL) relation (not to be quasi-co-location (QCL)). Reception of the multi-PDSCHs may be replaced with simultaneous reception of PDSCHs that are not of a certain QCL type (for example, QCL type D).

A plurality of PDSCHs (which may be referred to as multiple PDSCHs (multi-PDSCHs)) from the multi-TRPs may be scheduled by using one piece of DCI (single DCI, single PDCCH) (single master mode, single-DCI based multi-TRPs). Each of the plurality of PDSCHs from the multi-TRPs may be scheduled by using a plurality of pieces of DCI (a plurality of DCI, multi-DCI or multiple PDCCHs) (multi-master mode, multi-DCI based multi-TRPs).

In URLLC for multi-TRPs, support of PDSCH (transport block (TB) or codeword (CW)) repetition across multi-TRPs has been studied. It has been studied that a repetition scheme (URLLC schemes, e.g., Schemes 1, 2a, 2b, 3, and 4) across multi-TRPs on a frequency domain, a layer (spatial) domain, or a time domain is supported. In Scheme 1, multi-PDSCHs from mult-TRPs are subject to space division multiplexing (SDM). In Schemes 2a and 2b, a PDSCH from multi-TRPs is subjected to frequency division multiplexing (FDM). In Scheme 2a, a redundancy version (RV) is the same for the multi-TRPs. In Scheme 2b, the RVs may be the same or different for the multi-TRPs. In Schemes 3 and 4, multi-PDSCHs from multi-TRPs are subjected to time division multiplexing (TDM). In Scheme 3, the multi-PDSCHs from the multi-TRPs are transmitted in one slot. In Scheme 4, the multi-PDSCHs from the multi-TRPs are transmitted in different slots.

Such a multi-TRP scenario can perform more flexible transmission control using a high-quality channel.

In RRC configuration information for linking a plurality of pairs of PDCCHs and PDSCHs having a plurality of TRPs, one control resource set (CORESET) in PDCCH configuration information (PDCCH-Config) may correspond to one TRP to support intra-cell (having the same cell ID) and inter-cell (having different cell IDs) multi-TRP transmission based on the plurality of PDCCHS.

When at least one of the following conditions 1 and 2 is satisfied, the UE may determine the multi-TRPs based on the multi-DCI. In this case, the TRP may be replaced with a CORESET pool index.

### [Condition 1]

A CORESET pool index of 1 is set.

### [Condition 2]

Two different values (for example, 0 and 1) of the CORESET pool index are set.

The UE may determine multi-TRPs based on single DCI in a case where the following condition is met:. In this case, the two TRPs may be replaced with two TCI states instructed by MAC CE/DCI.

### [Condition]

“Enhanced TCI States Activation/Deactivation for UE-specific PDSCH MAC CE” is used to instruct one or two TCI states for one code point in a TCI field in the DCI.

The DCI for the common beam instruction may be a UE-specific DCI format (for example, DL DCI format (for example, 1_1 and 1_2), UL DCI format (for example, 0_1 and 0_2)) or a UE-group common DCI format.

### (Multi-TRP PDCCH)

For reliability of a multi-TRP PDCCH based on a non-single frequency network (SFN), the following studies 1 to 3 have been examined.

[Study 1] Coding/rate matching is based on one repetition, and the same coded bit is repeated in other repetitions.
[Study 2] Each repetition has the same control channel element (CCE) number and the same coded bit, and corresponds to the same DCI payload.
[Study 3] Two or more PDCCH candidates are explicitly linked to each other. The UE learns the link before decoding.

The following options 1-2, 1-3, 2, and 3 for PDCCH repetition have been considered:

### [Option 1-2]

Two sets of PDCCH candidates (within a given search space (SS) set) are respectively associated with two TCI states of the CORESET. Here, the same CORESET, the same SS set, and PDCCH repetition in different monitoring occasions are used.

### [Option 1-3]

Two sets of PDCCH candidates are respectively associated with two sets of SSs. Both the SS sets are associated with a CORESET, and each SS set is associated with only one TCI state for the CORESET. Here, the same CORESET, two SS sets, are used.

### [Option 2]

One SS set is associated with two different CORESETs.

### [Option 3]

Two sets of SSs are respectively associated with two CORESETs.

In this way, it is considered that two PDCCH candidates in the two SS sets for PDCCH repetition are supported, and the two SS sets are explicitly linked.

### (Determination of PDCCH Candidate Allocation)

In Rel. 15 NR, for common search space (CSS), a network (NW) ensures that overbooking (excessive allocation) does not occur. The UE does not assume that for monitored PDCCH candidates per slot and non-overlapped control channel elements (CCE), CCS sets are configured that cause the corresponding total number or number per scheduled cell to exceed the corresponding maximum number per slot.

In Rel. 15 NR, for a secondary cell (SCell), a network (NW) ensures that overbooking based on a (non-CA) case where carrier aggregation (CA) is not performed does not occur. For cross-carrier scheduling when a scheduling cell and a scheduled cell have a plurality of DL BWPs with the same subcarrier spacing (SCS) configuration u, or scheduling of the same cell, the UE does not assume that the number of PDCCH candidates and the number of non-overlapped CCEs per slot on the SCell will be greater than the corresponding number per slot that the UE can monitor on the SCell.

The UE does not assume to monitor PDCCHs in a USS set that do not have PDCCHs allocated for monitoring.

First, PDCCH candidates for a CSS set are allocated, and then PDCCH candidates for a UE-specific search space (USS) set are allocated according to ascending order of search space set indexes (IDs) (in order from the lowest search space set ID).

The CSS has a higher priority than the USS.

All PDCCH candidates of a USS set with a lower SS set ID are mapped before PDCCH candidates of a USS set with a higher SS set ID. In a case where all PDCCH candidates in a certain SS set (USS) cannot be mapped (there is not enough room for PDCCH candidates for the SS set (the number of remaining PDCCH candidates up to the maximum number)), PDCCH candidates in the SS set and the subsequent SS set are dropped (not mapped). In the order of SS set IDs, an SS set after a certain SS set may be referred to as a subsequent SS set.

In a case where a higher layer index is set per CORESET for a UE supporting multi-PDCCH (multi-DCI) based multi-TRP transmission, the UE may support the following principle for the maximum numbers of BDs and CCEs for the multi-DCI based multi-TRP transmission:

For a CORESET configured for the same TRP (same upper layer index), the maximum number of PDCCH candidates monitored per slot in a certain DL BWP may not exceed a limit M_{PDCCH}^{max,slot,μ} in Rel. 15, and the maximum number of non-overlapped CCEs may not exceed a limit C_{PDCCH}^{max,slot,μ} in Rel. 15. The upper layer index may be set for each PDCCH configuration information (PDCCH-Config) and for each CORESET. The higher layer index may correspond to a TRP.

The UE may indicate the ability to monitor the PDCCH according to one or more combinations (X, Y). One span may be a continuous symbol in which the UE is configured to monitor the PDCCHs in one slot. Each PDCCH monitoring occasion may be within one span. In a case where the UE monitors the PDCCHs on one cell according to a combination (X, Y), the UE supports a plurality of PDCCH monitoring occasions in any symbol of one slot with a minimum time interval (separation) of X symbols between the first symbols of two consecutive spans including spanning to a plurality of slots. One span starts at the first symbol at which a certain PDCCH monitoring occasion starts and ends at the last symbol at which a certain PDCCH monitoring occasion ends, and the number of symbols in the span is up to Y.

A maximum number M_{PDCCH}^{max,(X, Y),μ} of monitored PDCCH candidates in one span for a combination (X, Y) in a DL BWP with subcarrier spacing (SCS) configuration μ∈{0, 1} for a single serving cell may be defined in the specification. A maximum number C_{PDCCH}^{max,(X, Y),μ} of non-overlapped CCEs in one span for a combination (X, Y) in a DL BWP with subcarrier spacing (SCS) configuration μ∈{0, 1} for a single serving cell may be specified in the specification.

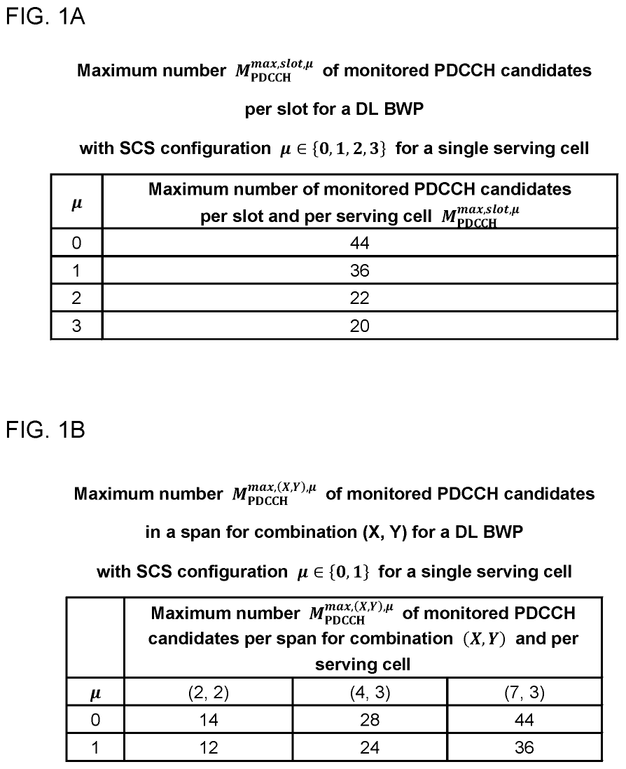

FIG. 1A illustrates a maximum number M_{PDCCH}^{max,slot,μ} of monitored PDCCH candidates per slot for a DL BWP with SCS configuration μ∈{0, 1, 2, 3} for an operation using a single serving cell. FIG. 1B illustrates the maximum number M_{PDCCH}^{max,(X, Y),μ} of monitored PDCCH candidates in one span for a combination (X, Y) in a DL BWP with subcarrier spacing (SCS) configuration μ∈{0, 1} for a single serving cell.

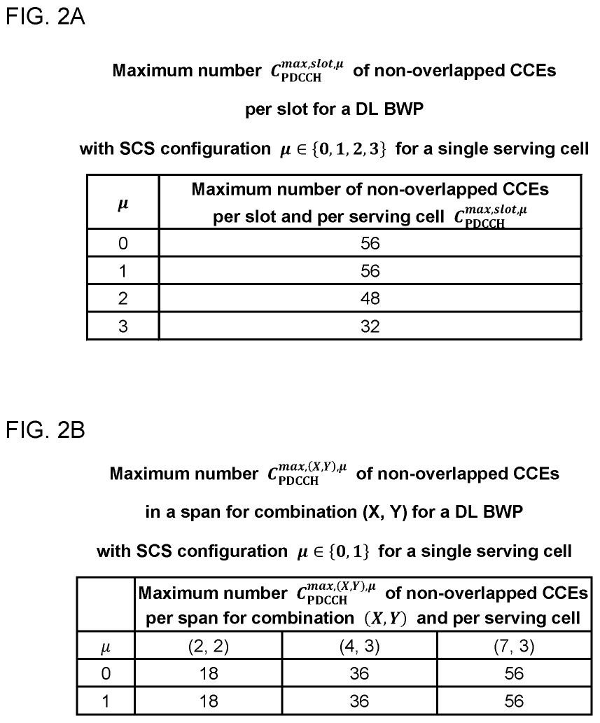

FIG. 2A illustrates the maximum number C_{PDCCH}^{max,slot,μ} of non-overlapped CCEs per slot for a DL BWP with SCS configuration μ∈{0, 1, 2, 3} for an operation using a single serving cell. FIG. 2B illustrates the maximum number M_{PDCCH}^{max,(X, Y),μ} of non-overlapped CCEs in one span for a combination (X, Y) in a DL BWP with subcarrier spacing (SCS) configuration μ∈{0, 1} for a single serving cell. In a case where the CCEs for the PDCCH candidates correspond to different CORESET indexes or different first symbols for receiving the respective PDCCH candidates, the CCEs do not overlap.

In the case of Σ_{μ-0}³N_{cells}^{DL,μ}≤N_{cells}^{cap}, and in a case where the UE configures N_{cells}^{DL,μ} DL cells with a DL BWP with SCS configuration μ, the UE is not required to monitor PDCCH candidates more than M_{PDCCH}^{total,slot,μ}=M_{PDCCH}^{max,slot,μ} or non-overlapped CCEs more than C_{PDCCH}^{total,slot,μ}=C_{PDCCH}^{max,slot,μ} per slot for each scheduled cell on the active DL BWP of the scheduling cell. N_{cells}^{cap} may be a value of capability information (pdcch-BlindDetectionCA) provided by the UE, or may be a configured number of DL cells.

### (Analysis)

For two linked SS sets/PDCCH candidates for repetition, in the case of PDCCH overbooking, both of the two linked SS sets/PDCCH candidates are preferably allocated. However, it is not clear how to extend the PDCCH allocation procedure in PDCCH overbooking.

It has been considered that the SS sets/PDCCH candidates are first allocated in order of SS set ID, and in a case where one SS set with a lower ID in the linked SS sets is allocated, the other SS set with a higher ID is also allocated together.

It has been considered that when one of the linked PDCCH candidates uses the same set of CCEs as a single (individual, not linked) PDCCH candidate, both the PDCCH candidates are associated with the same DCI size, the same scrambling, the same CORESET for BD counting and interpretation of the detected DCI. Furthermore, it has been studied that a single PDCCH candidate is not counted for monitoring.

It is also contemplated that UEs that support reception using two different beams support identifying two QCL Type D properties for multiple overlapping CORESETs.

For reliability extension of the PDCCH having the non-SFN scheme and the foregoing studies 1 to 3, it has been considered to support the foregoing option 3 (two SS sets are respectively associated with two CORESETs).

It is contemplated that two linked sets of SSs for PDCCH repetition are configured/instructed by the RRC IE/MACCE. It is considered that two linked PDCCH candidates for PDCCH repetition are respectively in two linked SS sets, and have the same aggregation level and the same index.

The PDCCH/DCI to which repeated transmission is applied may be referred to as multi-PDCCHs/multi-DCI. The repeated transmission of the PDCCH may be read as PDCCH repetition, multiple transmission of the PDCCH, multi-PDCCH transmission, multiple PDCCH transmission, MTR PDCCH, or

The multi-PDCCHs/multi-DCI may be respectively transmitted from different TRPs. The multi-PDCCHs/DCI may be multiplexed using time division multiplexing (TDM)/frequency division multiplexing (FDM)/space division multiplexing (SDM).

For example, in a case where repetition of the PDCCH (TDM PDCCH repetition) is performed by using the TDM, the PDCCHs may be transmitted from a plurality of TRPs by using different time resources.

In a case where FDM PDCCH repetition is performed, the PDCCHs may be transmitted from the plurality of TRPs by using different frequency-time resources. In the FDM PDCCH repetition, at least one of two sets of resource element groups (REG), a control channel element (CCE) of a transmitted PDCCH, two transmitted PDCCH repetitions that do not overlap in frequency, and a transmitted PDCCH of a multi-opportunity that does not overlap in frequency may be associated with different TCI states.

In a case where SDM PDCCH repetition is performed, the PDCCHs may be transmitted from a plurality of TRPs by using the same time/frequency resource. In the SDM PDCCH repetition, PDCCH DMRSs in all REGs/CCEs of the PDCCHs may be related to two TCI states. Note that, in the present disclosure, the SDM may be replaced with a single frequency network (SFN).

A UE to which the FDM/SDM PDCCH repetition is applied should be able to receive multiple beams (multiple QCL Type D channels/signals) simultaneously. However, whether the control of the collision of the PDCCH in a case where the UE can simultaneously receive a plurality of beams (a plurality of channels/signals of QCL type D) complies with the above-described constraint (priority rule) has not yet been studied. In a case where this is not considered, transmission and reception of the UE is improperly restricted, and there is a possibility that throughput is reduced or communication quality is deteriorated.

It is preferable to use a priority rule suitable for at least one of the following cases:
A case of determining which PDCCH candidates/SS sets are allocated in PDCCH overbooking.
A case to determine which PDCCH candidates/CORESETs are monitored in QCL type D collision handling.
A case of determining which PDCCH candidates are counted in two PDCCH candidates having the same set of CCEs, which are associated with the same DCI size and the same scrambling.

In Rel. 15/16, a rule in which a lower SS set ID has a higher priority is used.

How to extend the procedure of allocating/counting/selecting/determining PDCCH candidates/SS sets/CORESETs to be monitored is a problem. For example, whether a linked PDCCH candidate is prioritized over a single PDCCH candidate becomes a problem. In a case where the PDCCH candidates/SS sets/CORESETs to be monitored are not appropriately determined, there is a possibility of causing a decrease in communication quality, a decrease in communication throughput, and the like.

Therefore, the present inventors have conceived a method of counting/allocating/selecting/determining PDCCH candidates/SS sets/CORESETs.

Embodiments according to the present disclosure will be described in detail below with reference to the drawings. A radio communication method according to each embodiment may be applied individually or in combination.

In the present disclosure, “A/B/C” and “at least one of A, B and C” may be read as each other. In the present disclosure, a cell, a serving cell, a CC, a carrier, a BWP, a DL BWP, a UL BWP, an active DL BWP, an active UL BWP, and a band may be replaced with each other. In the present disclosure, an index, an ID, an indicator, and a resource ID may be replaced with each other. In the present disclosure, a sequence, a list, a set, a group, a cluster, a subset, and the like may be replaced with each other. In the present disclosure, “support”, “control”, “be controllable”, “operate”, and “be operable” may be replaced with each other.

In the present disclosure, “configure”, “activate”, “update”, “indicate”, “enable”, “specify”, and “select” may be replaced with each other.

In the present disclosure, “link”, “have a linkage”, “associate”, “correspond”, “map”, “repeat”, and “relate” may be replaced with each other. In the present disclosure, “allocate”, “assign”, “monitor”, and “map” may be replaced with each other.

In the present disclosure, the higher layer signaling may be any of, for example, radio resource control (RRC) signaling, medium access control (MAC) signaling, broadcast information, and the like, or a combination thereof. In the present disclosure, the RRC, the RRC signaling, an RRC parameter, a higher layer parameter, an RRC information element (IE), an RRC message, and a configuration may be replaced with each other.

For example, a MAC control element (MAC CE), a MAC protocol data unit (PDU), or the like may be used for the MAC signaling. Broadcast information may be, for example, a master information block (MIB), a system information block (SIB), remaining minimum system information (RMSI), other system information (OSI), or the like.

In the present disclosure, the MAC CE and activation/deactivation commands may be read as each other.

In the present disclosure, a beam, a spatial domain filter, a spatial setting, a TCI state, a UL TCI state, a unified TCI state, a unified beam, a common TCI state, a common beam, a TCI assumption, a QCL assumption, a QCL parameter, a spatial domain reception filter, a UE spatial domain reception filter, a UE reception beam, a DL beam, a DL reception beam, DL precoding, a DL precoder, a DL-RS, an RS of QCL type D of a TCI state/QCL assumption, an RS of QCL type A of a TCI state/QCL assumption, a spatial relation, a spatial domain transmission filter, a UE spatial domain transmission filter, a UE transmission beam, a UL beam, a UL transmission beam, UL precoding, a UL precoder, a PL-RS, an antenna port, a panel group, and a beam group may be replaced with each other. In the present disclosure, a QCL type X-RS, a DL-RS associated with a QCL type X, a DL-RS with the QCL type X, a source of the DL-RS, an SSB, a CSI-RS, and an SRS may be replaced with each other.

In the present disclosure, a panel, an uplink (UL) transmission entity, a TRP, a spatial relation, a control resource set (Control REsource SET (CORESET)), a PDSCH, a codeword, a base station, an antenna port (for example, a demodulation reference signal (DMRS) port) of a certain signal, an antenna port group (for example, a DMRS port group) of a certain signal, a group for multiplexing (for example, a code division multiplexing (CDM) group, a reference signal group, and a CORESET group), a CORESET pool, a CORESET subset, a CW, a redundancy version (RV), and a layer (MIMO layer, transmission layer, and spatial layer) may be replaced with each other.

The panel may relate to at least one of a group index of an SSB/CSI-RS group, a group index of group-based beam reporting, and a group index of the SSB/CSI-RS group for the group-based beam reporting.

Furthermore, a panel identifier (ID) and the panel may be replaced with each other. That is, a TRP ID and a TRP, a CORESET group ID and a CORESET group, and the like may be replaced with each other.

In the present disclosure, a TRP, a transmission point, a panel, a DMRS port group, a CORESET pool, one of two TCI states associated with one codepoint in a TCI field may be replaced with each other.

In the present disclosure, a single PDCCH may be assumed to be supported when multi-TRPs use ideal backhaul. Multi-PDCCHs may be assumed to be supported when the multi-TRPs use non-ideal backhaul.

Note that the ideal backhaul may be referred to as a DMRS port group type 1, a reference signal related group type 1, an antenna port group type 1, a CORESET pool type 1, and the like. Note that the non-ideal backhaul may be referred to as a DMRS port group type 2, a reference signal related group type 2, an antenna port group type 2, a CORESET pool type 2, and the like. The name is not limited thereto.

In the present disclosure, a single TRP, a single TRP system, single TRP transmission, and a single PDSCH may be replaced with each other. In the present disclosure, multi-TRPs, a multi-TRP system, multi-TRP transmission, and multi-PDSCHs may be replaced with each other. In the present disclosure, single DCI, a single PDCCH, multi-TRPs based on the single DCI, and activating two TCI states on at least one TCI code point may be replaced with each other.

In the present disclosure, a single TRP, a channel using the single TRP, a channel using one TCI state/spatial relation, multi-TRPs not activated by RRC/DCI, multiple TCI states/spatial relations not activated by RRC/DCI, and no CORESET pool index (CORESETPoolIndex) value of 1 configured for any CORESET and no codepoint in a TCI field mapped to two TCI states may be replaced with each other.

In the present disclosure, multi-TRPs, a channel using the multi-TRPs, a channel using a plurality of TCI states/spatial relations, multi-TRPs activated by RRC/DCI, a plurality of TCI states/spatial relations activated by the RRC/DCI, and at least one of multi-TRPs based on single DCI and multi-TRPs based on multi-DCI may be replaced with each other. In the present disclosure, multi-TRPs based on multi-DCI and setting of a CORESET pool index (CORESETPoolIndex) value of 1 to a CORESET may be replaced with each other. In the present disclosure, multi-TRPs based on single DCI, and at least one code point in a TCI field mapped to two TCI states may be replaced with each other.

In the present disclosure, a TRP #1 (first TRP) may correspond to a CORESET pool index=0, or may correspond to a first TCI state of two TCI states corresponding to one code point in a TCI field. A TRP #2 (second TRP) TRP #1 (first TRP) may correspond to the CORESET pool index=1, or may correspond to a second TCI state of two TCI states corresponding to one code point in the TCI field.

In the present disclosure, a DMRS, a DMRS port, and an antenna port may be replaced with each other.

In the present disclosure, a QCL and a QCL type D may be replaced with each other.

In the present disclosure, the number of PDCCH candidates to be monitored and the number of blind detections (BD) may be replaced with each other. The number of non-overlapped CCEs, the number of CCEs for channel estimation, and the number of CCEs may be replaced with each other.

In the present disclosure, a limit, an upper limit, a restriction, and a maximum number may be replaced with each other.

In the present disclosure, a slot, a span, a continuous symbol, and a time domain resource may be replaced with each other.

### (Radio Communication Method)

The following embodiments also describe whether or not linked multiple PDCCH candidates are prioritized regardless of an SS set ID. For example, in a case where IDs of both SS sets in a linked SS set pair are higher than an ID of a single SS set, it is not clear whether or not the SS set pair is prioritized, so it is also mentioned as to which of the linked SS set pair {SS set ID #1, SS set ID #2} and the single (unlinked) SS set {SS set ID #0} is prioritized.

In the case of being based on the SS set ID, the priority of the SS set ID #0> the priority of the {SS set ID #1, SS set ID #2}. A small extension based on Rel. 15/16 is conceivable. This extension is that the two linked SS sets are counted together.

In a case where priority is given to multiple linked SS sets, the priority of the {SS set ID #1, SS set ID #2}> the priority of the SS set ID #0. A large extension based on Rel. 15/16 is conceivable. This extension is that the two linked SS sets are counted together.

In each of the following embodiments, it may be assumed that two linked sets of SSs are in the same slot/span.

The maximum number of PDCCH candidates/non-overlapped CCEs that the UE can monitor may be defined per slot/span. The allocation of the PDCCH candidates may be per slot/span.

That the SS sets/PDCCH candidates/PDCCH candidates in the SS sets can be allocated, that there is room for sufficient PDCCH candidates/non-overlapped CCEs for the SS sets/PDCCH candidates/PDCCH candidates in the SS sets, that there is a remaining number of the PDCCH candidates/non-overlapped CCEs up to a maximum number for the SS sets/PDCCH candidates/PDCCH candidates in the SS sets, and that there are sufficient PDCCH candidates/non-overlapped CCEs for the SS sets/PDCCH candidates/PDCCH candidates in the SS sets may be replaced with each other.

A plurality of SS sets (SS set pairs) having the linkage (combination, cooperation) may mean that one SS set is linked with the other SS set via the RRC IE/MAC CE for PDCCH repetition. An SS set without a linkage (an individual SS set) may mean that the SS set is not linked with another SS set via the RRC IE/MAC CE via an RRC IE/MAC CE.

In the present disclosure, a pair having a linkage and a linked pair may be replaced with each other. In the present disclosure, no linkage, unlinked, and alone may be replaced with each other.

“Priority of SS set #A> priority of SS set #B” may mean that the priority of the SS set #A is higher than the priority of the SS set #B, or that the SS set #A is allocated with priority over the SS set #B.

A CSS set with a linkage may or may not be supported. If not, in a priority rule of each embodiment, the CSS set with the linkage may be ignored.

The SS set ID of an SS set pair may refer to a lower SS set ID in the two linked SS sets. For example, in a pair of linked SS sets {SS set ID #x, SS set ID #y}, in a case where ID #x is lower than ID #y, the SS set ID of the pair of SS sets for comparison may refer to ID #x.

In each of the following embodiments, allocating a pair of linked SS sets together may mean the following operations 1 and 2.

### [Operation 1]

In a case where both SS sets can be allocated, both the SS sets are allocated.

### [Operation 2]

In a case where both the SS sets cannot be allocated, one of the following operations 2-1 and 2-2 is performed.

[Operation 2-1] Both the SS sets are not allocated.
[Operation 2-2] In a case where an SS set having a lower ID among the pairs can be allocated, the SS set is allocated.

In the present disclosure, two linked CORESETs for PDCCH repetition may mean two CORESETs respectively associated with two linked SS sets.

The UE may determine a plurality of targets to be monitored from a plurality of candidates of any one of the SS set, the PDCCH candidate, and the CORESET. The UE may monitor the plurality of targets. The UE may preferentially include, in the plurality of targets, a first candidate having a linkage with another candidate among the plurality of candidates and a second candidate corresponding to a common search space set.

The UE may determine/allocate/count/select a plurality of targets among the plurality of candidates provided that the PDCCH candidates/non-overlapped CCEs are not greater than or equal to the maximum number.

### First Embodiment

In a PDCCH candidate allocation in PDCCH overbooking, when PDCCH candidates/non-overlapped CCEs are counted towards a maximum number, SS sets/PDCCH candidates may be allocated/counted in descending order of priority according to at least one of the following priority rules 1-1 to 1-3.

### [Priority Rule 1-1]

Priority of an SS set with a linkage> priority of an SS set without a linkage.

### [Priority Rule 1-2]

Pairs of linked SS sets are co-located.

Among a plurality of SS sets with linkages, priority of a CSS set> priority of a USS set.

Among a plurality of CSS sets with linkages, priority of an SS set pair with a lower SS set ID> priority of an SS set pair with a higher SS set ID.

Among a plurality of USS sets with linkages, priority of an SS set pair with a lower SS set ID> priority of an SS set pair with a higher SS set ID.

### [Priority Rule 1-3]

Among a plurality of SS sets without linkages, priority of a CSS set> priority of a USS set.

Among a plurality of CSS sets without linkages, priority of an SS set pair with a lower SS set ID> priority of an SS set pair with a higher SS set ID.

Among a plurality of USS sets without linkages, priority of an SS set pair with a lower SS set ID> priority of an SS set pair with a higher SS set ID.

### Specific Example

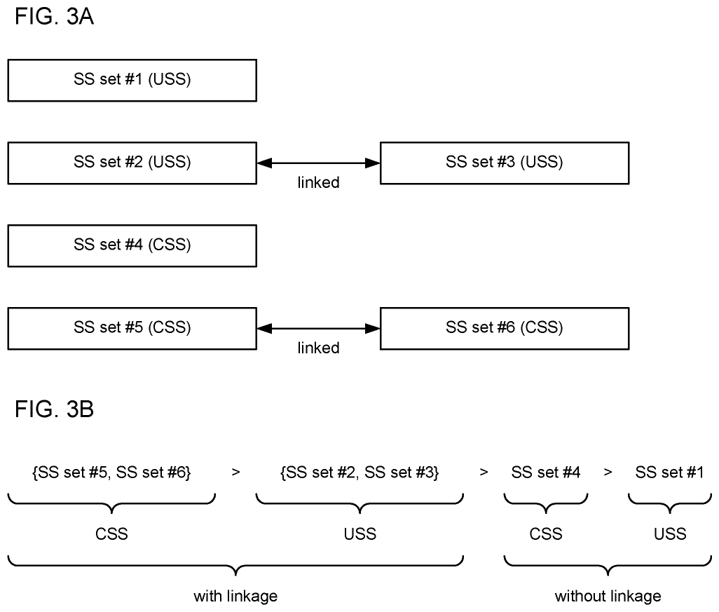

In an example of FIG. 3A, the SS sets #1, #2, and #3 are USS sets, and the SS sets #4, #5, and #6 are CSS sets. The SS sets #2 and #3 are linked together for PDCCH repetition. The SS sets #5 and #6 are linked together for PDCCH repetition.

According to the priority rules 1-1 to 1-3, as illustrated in FIG. 3B, the SS sets #1 to #6 are allocated/counted in the order of {SS set #5, SS set #6}, {SS set #2, SS set #3}, SS set #4, and SS set #1.

According to this embodiment, the SS sets with linkages can be prioritized, and then the CSS sets can be prioritized, and the SS sets/PDCCH candidates can be appropriately allocated/determined/selected/counted.

### Second Embodiment

In a PDCCH candidate allocation in PDCCH overbooking, when PDCCH candidates/non-overlapped CCEs are counted towards a maximum number, SS sets/PDCCH candidates may be allocated/determined/selected/counted in descending order of priority according to at least one of the following priority rules 2-1 to 2-3.

### [Priority Rule 2-1]

Priority of a CSS set> priority of a USS set.

### [Priority Rule 2-2]

Among a plurality of CSS sets, priority of a CSS set with a linkage> priority of a CSS set without a linkage.

Among a plurality of CSS sets with linkages, pairs of linked SS sets are co-located.

Among a plurality of CSS sets with linkages, priority of an SS set pair with a lower SS set ID> priority of an SS set pair with a higher SS set ID.

Among a plurality of CSS sets without linkages, priority of an SS set pair with a lower SS set ID> priority of an SS set pair with a higher SS set ID.

### [Priority Rule 2-3]

Among a plurality of USS sets, priority of a USS set with a linkage> priority of a USS set without a linkage. Among a plurality of USS sets with linkages, pairs of linked SS sets are co-located.

Among a plurality of USS sets with linkages, priority of an SS set pair with a lower SS set ID> priority of an SS set pair with a higher SS set ID.

Among a plurality of USS sets without linkages, priority of an SS set pair with a lower SS set ID> priority of an SS set pair with a higher SS set ID.

### Specific Example

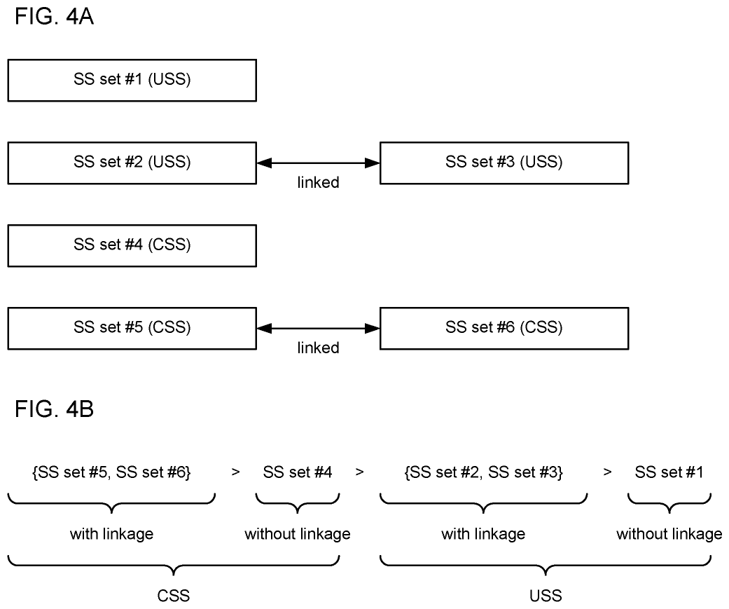

In an example of FIG. 4A, the SS sets #1, #2, and #3 are USS sets, and the SS sets #4, #5, and #6 are CSS sets. The SS sets #2 and #3 are linked together for PDCCH repetition. The SS sets #5 and #6 are linked together for PDCCH repetition.

According to the priority rules 2-1 to 2-3, as illustrated in FIG. 4B, the SS sets #1 to #6 are allocated/counted in the order of {SS set #5, SS set #6}, SS set #4, {SS set #2, SS set #3}, and SS set #1.

According to this embodiment, the CSS sets can be prioritized, and then the SS sets with linkages can be prioritized, and the SS sets/PDCCH candidates can be appropriately allocated/determined/selected/counted.

### Third Embodiment

In a PDCCH candidate allocation in PDCCH overbooking, when PDCCH candidates/non-overlapped CCEs are counted towards a maximum number, SS sets/PDCCH candidates may be allocated/determined/selected/counted in descending order of priority according to at least one of the following priority rules 3-1 to 3-3.

### [Priority Rule 3-1]

Priority of a CSS set> priority of a USS set.

### [Priority Rule 3-2]

Among a plurality of CSS sets, pairs of linked SS sets are co-located.

Among a plurality of CSS sets, priority of an SS set pair with a lower SS set ID/sole SS set> priority of an SS set pair with a higher SS set ID/sole SS set.

### [Priority Rule 3-3]

Among a plurality of USS sets, pairs of linked SS sets are co-located.

Among a plurality of USS sets, priority of an SS set pair with a lower SS set ID/sole SS set> priority of an SS set pair with a higher SS set ID/sole SS set.

### Specific Example

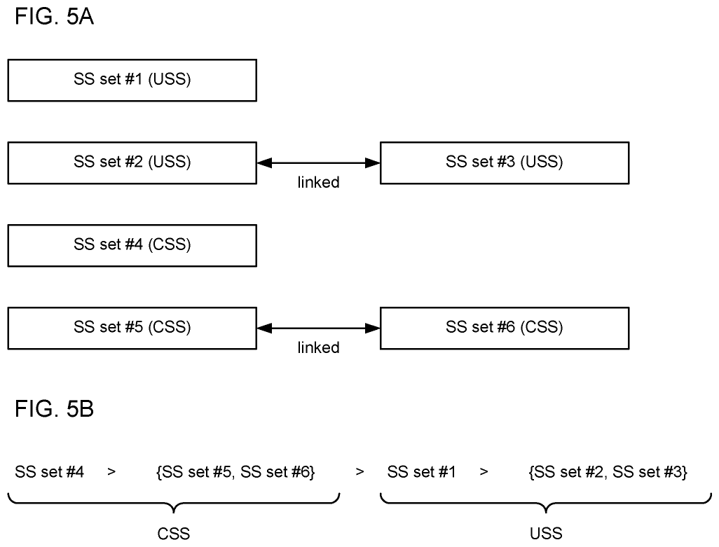

In an example of FIG. 5A, the SS sets #1, #2, and #3 are USS sets, and the SS sets #4, #5, and #6 are CSS sets. The SS sets #2 and #3 are linked together for PDCCH repetition. The SS sets #5 and #6 are linked together for PDCCH repetition.

According to the priority rules 3-1 to 3-3, as illustrated in FIG. 5B, the SS sets #1 to #6 are allocated/counted in the order of the SS set #4, {SS set #5, SS set #6}, the SS set #1, and {SS set #2, SS set #3}.

According to this embodiment, the CSS sets can be prioritized, and then the SS sets with lower IDs can be prioritized, and the SS sets/PDCCH candidates can be appropriately allocated/determined/selected/counted.

### Fourth Embodiment

In a PDCCH candidate allocation in PDCCH overbooking, when PDCCH candidates/non-overlapped CCEs are counted towards a maximum number, different priority rules may be applied to CSS sets and USS sets.

The SS sets/PDCCH candidates may be allocated/determined/selected/counted in descending order of priority according to at least one of the following 4-1 and 4-2.

### [Priority Rule 4-1]

Priority of a CSS set> priority of a USS set.

### [Priority Rule 4-2]

One of the following priority rules 4-2-1 to 4-2-3 may be applied to a priority rule among a plurality of CSS sets or a priority rule among a plurality of USS sets. Different priority rules may be applied to the CSS sets and the USS sets, or the same priority rule may be applied.

### [[Priority Rule 4-2-1] ]

The first/second embodiments apply to CSS sets/USS sets. Pairs of linked SS sets are co-located. Priority of an SS set with a linkage> priority of an SS set without a linkage.

### [[Priority Rule 4-2-2] ]

The third embodiment is applied to CSS sets/USS sets. Pairs of linked SS sets are co-located. Priority of an SS set pair with a lower ID/sole SS set> priority of an SS set pair with a higher ID/sole SS set.

### [[Priority Rule 4-2-3] ]

Each SS set is individually allocated. Priority of an SS set with a lower ID> priority of an SS set with a higher ID.

According to this embodiment, different priorities can be applied to the CSS sets and the USS sets, and the SS sets/PDCCH candidates can be appropriately allocated/determined/selected/counted.

### Fifth Embodiment

The same priority rule may be applied to at least two of the following cases 1 to X.

### [Case 1]

A case of determining which PDCCH candidate/SS set is allocated in PDCCH overbooking.

### [Case 2]

A case of determining which PDCCH candidates/CORESETs are monitored in QCL type D collision handling.

### [Case 3]

A case of determining which PDCCH candidate is counted in two PDCCH candidates that have a same set of CCEs and that are associated with the same DCI size and the same scrambling.

### [Case X]

A case where a priority rule is used to determine one monitored PDCCH candidate/CORESET/SS set or a subset of the monitored PDCCH candidate/CORESET/SS set from a set of PDCCH candidates/CORESETs/SS sets.

The priority rule may be based on any one of the following indexes 1 to 4.

### [Index 1]

Order of SS set IDs.

### [Index 2]

Whether the SS set ID is a CSS set or a USS set.

### [Index 3]

Whether or not a PDCCH candidate/SS set/CORESET is linked with another PDCCH candidate/SS set/CORESET.

### [Index 4]

A combination of at least two of the indexes 1 to 3.

Specifically, the priority rule may be according to at least one of the following rules 1 to 3:

### [Rule 1]

Priority rules in the first, second, third, and fourth embodiments.

### [Rule 2]

Priority rule in Embodiment A1/A2 to be described later.

### [Rule 3]

Priority rule in Rel. 15/16. That is, priority of a CSS set> priority of a USS set, priority of an SS set with a lower ID> priority of an SS set with a higher ID.

According to this embodiment, from the set of PDCCH candidates/CORESETs/SS sets, several PDCCH candidates/CORESETs/SS sets to be monitored can be appropriately allocated/determined/selected/counted.

### Sixth Embodiment

An upper layer parameter (RRC information element)/UE capability corresponding to at least one function (characteristic, feature) in each embodiment may be defined. The UE capability may indicate whether or not to support this function.

The UE in which the upper layer parameter corresponding to the function is configured may perform the function. “The UE in which the upper layer parameter corresponding to the function is not configured does not perform the function (For example, the operation of Rel. 15/16 is applied.).” may be defined.

The UE that has reported the UE capability indicating support for the function may perform the function. “UEs that do not report the UE capability indicating support for the function do not perform the function (For example, the operation of Rel. 15/16 is applied.).” may be defined.

In a case where the UE reports the UE capability indicating that the UE supports the function, and an upper layer parameter corresponding to the function is configured, the UE may perform the function. “In a case where the UE does not report the UE capability indicating that the UE supports the function, or in a case where an upper layer parameter corresponding to the function is not configured, the UE does not perform the function (For example, the operation of Rel. 15/16 is applied.).” may be defined.

The UE capability may indicate at least one of the following:
Whether or not multi-TRP PDCCH repetition is supported.
For a CSS set, whether or not multi-TRP PDCCH repetition is supported.
Whether or not it is supported that linked SS sets are prioritized in PDCCH repetition.
For a CSS set, whether or not it is supported that linked SS sets are prioritized in PDCCH repetition.
For a USS set, whether or not it is supported that linked SS sets are prioritized in PDCCH repetition.

According to the above UE capability/upper layer parameter, the UE can realize the above function while maintaining compatibility with existing specifications.

### OTHER EMBODIMENTS

It should be noted that the following embodiments will be described assuming that the UE is applied when supporting simultaneous reception of two or more different QCL type D channels/signals, but may be applied otherwise.

“TCI state A is the same QCL type D as TCI state B”, “TCI state A is the same as TCI state B”, “TCI state A is TCI state B and QCL type D”, and the like in the present disclosure may be replaced with each other.

### Embodiment A1

Embodiment A1 relates to an SFN PDCCH repetition scheme.

In Embodiment A1, two or more TCI states may be activated per CORESET. The activation of the TCI state for the CORESET may be notified to the UE by using the MAC CE.

In Embodiment A1, in a case where a plurality of PDCCHs of different QCL types D collide, the UE determines a PDCCH (CORESET) to be monitored based on at least one priority rule shown in Embodiments 1.1 to 1.3. Each will be described below.

Hereinafter, in the present disclosure, the CORESET to be monitored determined from the priority rule is also simply referred to as “prioritized CORESET”, CORESET having the highest priority, or the like.

### Embodiment 1.1

A priority rule of Embodiment 1.1 is the same as that of Rel. 16 NR. That is, the UE determines the prioritized CORESET according to the priority rule that the CSS set is preferentially monitored over the USS set, and between SS sets of the same type (CSS or USS), an SS set with a smaller index (that is, the one with a smaller cell index, and in a case where the cell indices are the same, the one with a smaller SS set index) is preferentially monitored.

Embodiment 1.1 is further roughly divided into the following two:
Embodiment 1.1.1: The prioritized CORESET has two active TCI states (two QCL types D).
Embodiment 1.1.2: The prioritized CORESET has one active TCI state (one QCL type D).

### [[Embodiment 1.1.1] ]

For a CORESET other than the prioritized CORESET and having one active TCI state, the UE may monitor this CORESET in a case where the one active TCI state is of the same QCL type D as either of the two active TCI states of the prioritized CORESET.

For a CORESET other than the prioritized CORESET and having two active TCI states, the UE may monitor this CORESET in a case where the following condition (1.1.1a) or (1.1.1b) is met:
(1.1.1a) The two active TCI states are of the same QCL type D as the two active TCI states of the prioritized CORESET.
(1.1.1b) One of the two active TCI states is of the same QCL type D as one of the two active TCI states of the prioritized CORESET.

Note that in a case where the above (1.1.1b) is satisfied, the UE monitors the above CORESET by applying only the TCI state that is of the same QCL type D as one of the two active TCI states of the prioritized CORESET.

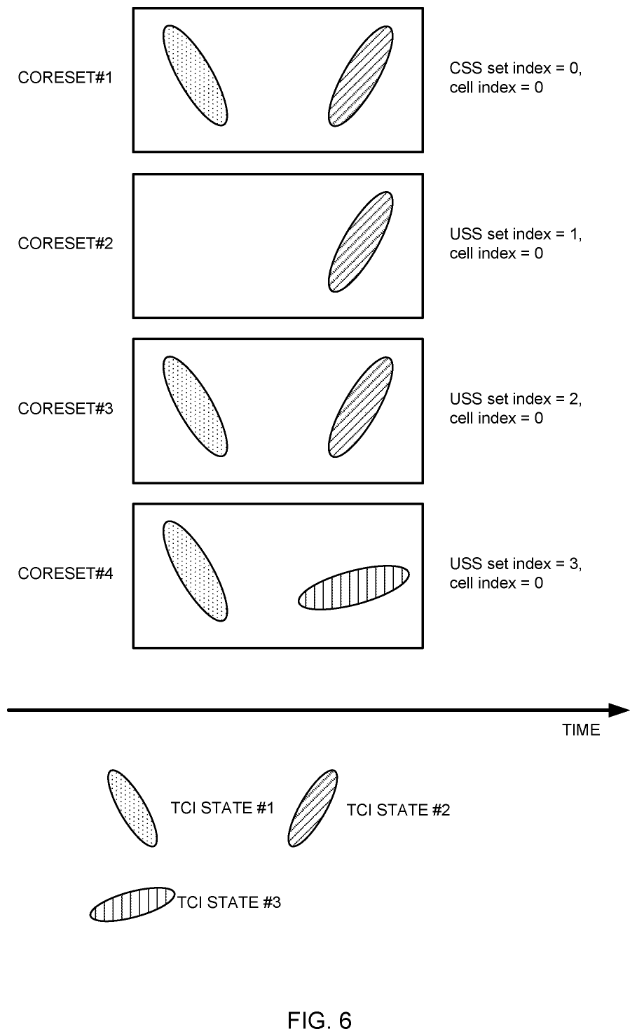

FIG. 6 is a diagram illustrating an example of a prioritized CORESET and another CORESET to be monitored simultaneously in Embodiment 1.1.1. In this example, four CORESETS (CORESETs #1 to #4) overlap in time.

CORESET #1 corresponds to CSS set index=0 and cell index=0, and has two active TCI states (TCI states #1 and #2).

CORESET #2 corresponds to USS set index=1 and cell index=0, and has one active TCI state (TCI state #2).

CORESET #3 corresponds to USS set index=2 and cell index=0, and has two active TCI states (TCI states #1 and #2).

CORESET #4 corresponds to USS set index=3 and cell index=0, and has two active TCI states (TCI states #1 and #3).

In the case of this figure, the UE first selects CORESET #1 corresponding to the CSS set as the prioritized CORESET. Since CORESET #1 has two active TCI states, the operation of Embodiment 1.1.1 is performed.

Since one TCI state of CORESET #2 is of QCL type D, which is the same as TCI state #2 of the prioritized CORESET, the UE monitors CORESET #2.

Since the two TCI states of CORESET #3 are of the same QCL type D as TCI states #1 and #2 of the prioritized CORESET, the UE monitors CORESET #3.

One of the two TCI states of CORESET #4 is of the same QCL type D as TCI state #1 of the prioritized CORESET, while the other is of a QCL type D (TCI state #3) different from TCI state #2 of the prioritized CORESET. Therefore, the UE according to (1.1.1a) above does not monitor CORESET #4. The UE according to (1.1.1b) above monitors CORESET #4 by applying only TCI state #1.

### [[Embodiment 1.1.2] ]

For Embodiment 1.1.2, a prioritized CORESET having one active TCI state that is first determined according to the same priority rule as Rel. 16 NR is also referred to as a first prioritized CORESET, and a prioritized CORESET other than the first prioritized CORESET that is subsequently determined is also referred to as a second prioritized CORESET. The second prioritized CORESET may be referred to as CORESET X.

One active TCI state of the first prioritized CORESET may be referred to as a first priority TCI state (1st priority TCI state). Any of the active TCI states of the second prioritized CORESET may be referred to as a second priority TCI state (2nd priority TCI state).

Embodiment 1.1.2 is roughly divided into Embodiments 1.1.2.1 and 1.1.2.2 according to a determination method of the second prioritized CORESET.

### [[Embodiment 1.1.2.1] ]

The second prioritized CORESET may be determined from remaining colliding CORESETs except the first prioritized CORESET according to a priority rule similar to that of Rel. 16. That is, the second prioritized CORESET may correspond to a smallest-index CSS set in a smallest-index cell including the CSS set, if any, among the remaining colliding CORESETs, or may otherwise correspond to a smallest-index USS set in the smallest-index cell. The smallest USS set index is determined across all USS sets with at least one PDCCH candidate in overlapping PDCCH monitoring opportunities.

In a case where a candidate of the second prioritized CORESET derived according to the above priority rule has only one active TCI state, and the active TCI state is the same as the first priority TCI state, the next candidate (a CORESET corresponding to the SS set/cell with the next smallest index) may be searched as the candidate of the second prioritized CORESET. That is, for a CORESET having only one active TCI state, the UE may continue searching for the second prioritized CORESET until the active TCI state is different from the first priority TCI state.

In a case where a CORESET having only one active TCI state different from the first priority TCI state is found according to the foregoing priority rule, the UE may determine the active TCI state as the second priority TCI state, and determine the CORESET as the second prioritized CORESET.

Note that even in a case where the candidate for the second prioritized CORESET derived according to the priority rule has only one active TCI state and the active TCI state is the same as the first priority TCI state, the UE may determine the active TCI state as the second priority TCI state and determine the candidate as the second prioritized CORESET. In this case, since the second prioritized CORESET is the same as the first prioritized CORESET, it may be expressed that there is no second prioritized CORESET.

In a case where the candidate of the second prioritized CORESET derived according to the priority rule has two active TCI states, and one of the two active TCI states is the same as the first priority TCI state, the UE may determine the other of the two active TCI states as the second priority TCI state, or may determine the candidate as the second prioritized CORESET.

Furthermore, in a case where the candidate of the second prioritized CORESET derived according to the priority rule has two active TCI states, and both of the two active TCI states are different from the first priority TCI state, the UE may determine one of the two active TCI states as the second priority TCI state, or may determine the candidate as the second prioritized CORESET. One of the TCI states may be the one having the smallest or largest TCI state ID between the two active TCI states, or may be the one corresponding to the first or second TCI state activated by the MAC CE.

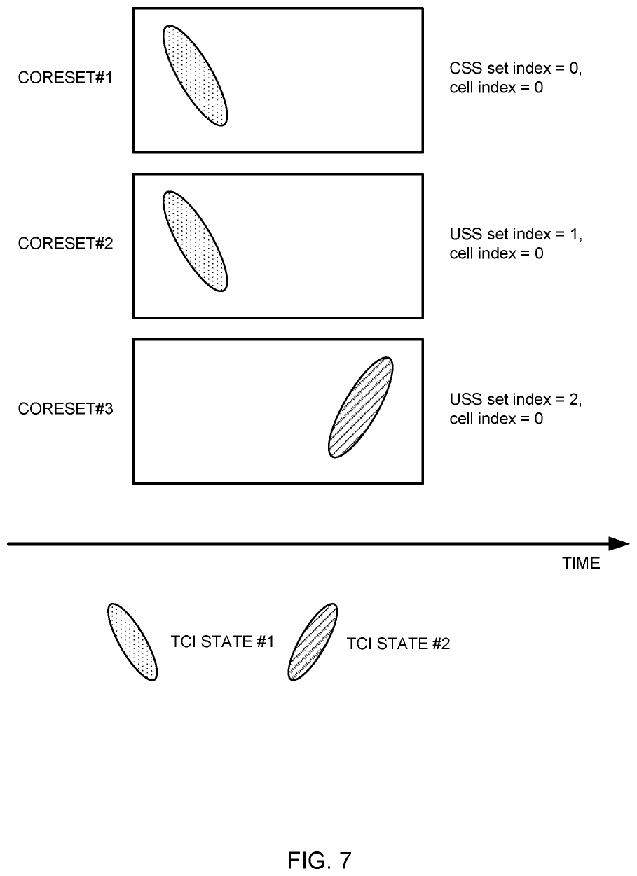

FIG. 7 is a diagram illustrating an example of a prioritized CORESET in Embodiment 1.1.2.1. In this example, three CORESETS (CORESETs #1 to #3) overlap in time.

CORESET #1 corresponds to CSS set index=0 and cell index=0, and has one active TCI state (TCI state #1).

CORESET #2 corresponds to USS set index=1 and cell index=0, and has one active TCI state (TCI state #1).

CORESET #3 corresponds to USS set index=2 and cell index=0, and has one active TCI state (TCI state #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Since one TCI state of CORESET #3 is different from TCI state #1 of the prioritized CORESET, the UE determines this TCI state #2 as the second priority TCI state, and determines and monitors CORESET #3 as the second prioritized CORESET.

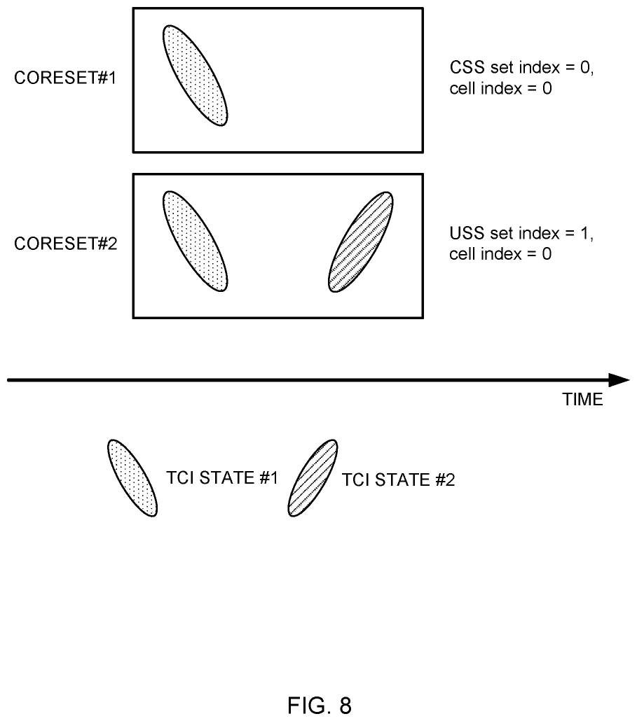

FIG. 8 is a diagram illustrating an example of a prioritized CORESET in Embodiment 1.1.2.1. In this example, two CORESETS (CORESETs #1 and #2) overlap with each other in terms of time.

CORESET #1 corresponds to CSS set index=0 and cell index=0, and has one active TCI state (TCI state #1).

CORESET #2 corresponds to USS set index=1 and cell index=0, and has two active TCI states (TCI states #1 and #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Since one of the two active TCI states of CORESET #2 is the same as the first priority TCI state, the UE determines the other of the two active TCI states (TCI state #2) as the second priority TCI state, and determines and monitors CORESET #2 as the second prioritized CORESET.

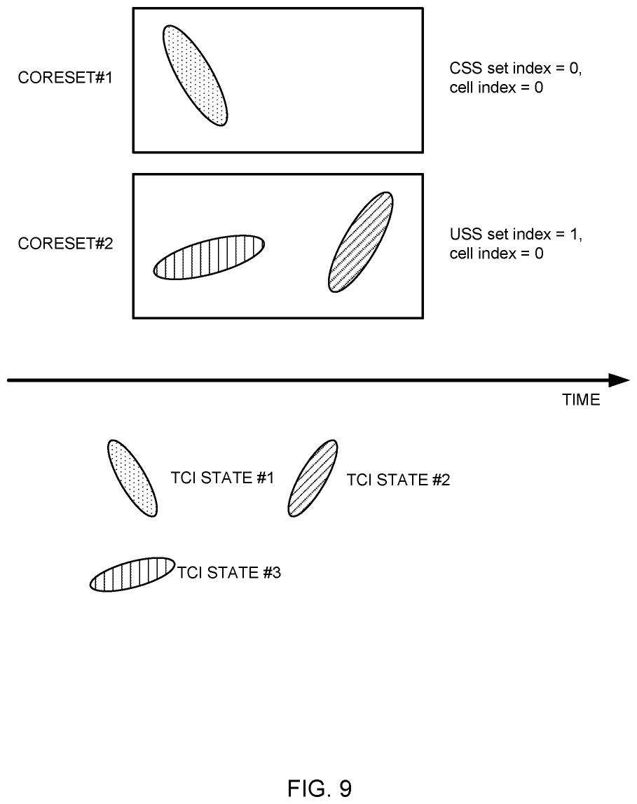

FIG. 9 is a diagram illustrating an example of a prioritized CORESET in Embodiment 1.1.2.1. In this example, two CORESETS (CORESETs #1 and #2) overlap with each other in terms of time.

CORESET #1 corresponds to CSS set index=0 and cell index=0, and has one active TCI state (TCI state #1).

CORESET #2 corresponds to USS set index=1 and cell index=0, and has two active TCI states (TCI states #3 and #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Since both of the two active TCI states of CORESET #2 are different from the first priority TCI state, the UE determines the TCI state having the largest TCI state ID (TCI state #3) of the two active TCI states as the second priority TCI state, determines CORESET #2 as the second prioritized CORESET, and in CORESET #2, applies only TCI state #3 to monitor the PDCCH candidates.

### Embodiment 1.1.2.2

From the remaining colliding CORESETs except the first prioritized CORESET, the UE first determines a subset of CORESETs that have two active TCI states, one of which is the same as the first priority TCI state.

Then, the UE determines the second prioritized CORESET from the subset according to the same priority rule as that of Rel. 16. That is, the second prioritized CORESET may correspond to the CSS set with the smallest index in the cell with the smallest index including the CSS set, if any, among the CORESETs included in the subset, or may correspond to the USS set with the smallest index in the cell with the smallest index, if not. The smallest USS set index is determined across all USS sets with at least one PDCCH candidate in overlapping PDCCH monitoring opportunities.

The second priority TCI state corresponds to one of the active TCI states of the second prioritized CORESET that is different from the first priority TCI state.

In Embodiment 1.1.2.2, in the second prioritized CORESET, the PDCCH candidate (CORESET) can be monitored using both the first priority TCI and the second priority TCI states.

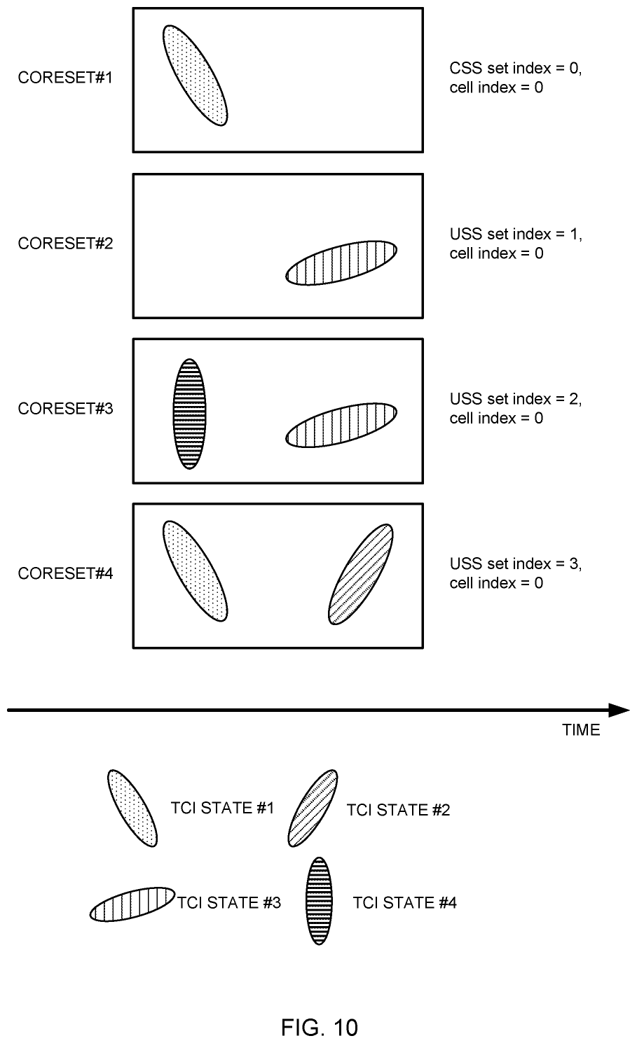

FIG. 10 is a diagram illustrating an example of a prioritized CORESET in Embodiment 1.1.2.2. In this example, four CORESETS (CORESETs #1 to #4) overlap in time.

CORESET #1 corresponds to CSS set index=0 and cell index=0, and has one active TCI state (TCI state #1).

CORESET #2 corresponds to USS set index=1 and cell index=0, and has one active TCI state (TCI state #3).

CORESET #3 corresponds to USS set index=2 and cell index=0, and has two active TCI states (TCI states #3 and #4).

CORESET #4 corresponds to USS set index=3 and cell index=0, and has two active TCI states (TCI states #1 and #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Out of the remaining CORESETs #2 to #4, only CORESET #4 has two active TCI states, and one of the TCI states is the same as the first priority TCI state. Therefore, the UE determines TCI state #2 different from the first priority TCI state among the TCI states of CORESET #4 as the second priority TCI state, determines CORESET #4 as the second prioritized CORESET, and monitors the PDCCH candidates by applying TCI states #1 and #2 in CORESET #4.

### [[CORESET Other Than Prioritized CORESET] ]

Monitoring of CORESET other than prioritized CORESETs (first prioritized CORESET and second prioritized CORESET) in Embodiment 1.1.2 will be described.

For a CORESET other than the prioritized CORESETs and having one active TCI state, the UE may monitor this CORESET in a case where the following condition (1.1.2a) or (1.1.2b) is met:
(1.1.2a) The one active TCI state is of the same QCL type D as the first priority TCI state.
(1.1.2b) The one active TCI state is the same QCL type D as the first priority TCI state or the second priority TCI state.

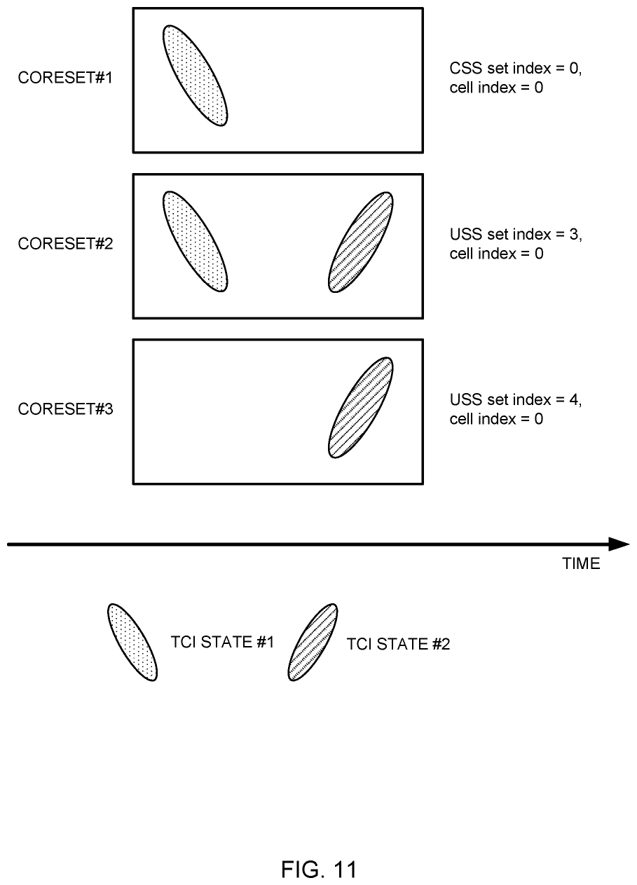

FIG. 11 is a diagram illustrating an example of a prioritized CORESET and another CORESET to be monitored simultaneously in Embodiment 1.1.2. In this example, three CORESETS (CORESETs #1 to #3) overlap in time.

CORESET #1 corresponds to CSS set index=0 and cell index=0, and has one active TCI state (TCI state #1).

CORESET #2 corresponds to USS set index=3 and cell index=0, and has two active TCI states (TCI states #1 and #2).

CORESET #3 corresponds to USS set index=4 and cell index=0, and has one active TCI state (TCI state #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Out of the remaining CORESETs #2 and #3, only CORESET #2 has two active TCI states, and one of the TCI states is the same as the first priority TCI state. Therefore, the UE determines TCI state #2 different from the first priority TCI state among the TCI states of CORESET #2 as the second priority TCI state, determines CORESET #2 as the second prioritized CORESET, and monitors the PDCCH candidates by applying TCI states #1 and #2 in CORESET #2.

The UE does not monitor CORESET #3 when considering the condition (1.1.2a). The UE monitors CORESET #3 when considering the condition (1.1.2b).

For a CORESET other than the prioritized CORESET and having two active TCI states, the UE may monitor this CORESET in a case where the following condition (1.1.2c) or (1.1.2d) or (1.1.2e) is met:
(1.1.2c) The two active TCI states are of the same QCL type D as the first priority TCI state and the second priority TCI state.
(1.1.2d) One of the two active TCI states is of the same QCL type D as the first priority TCI state.
(1.1.2e) One of the two active TCI states is a QCL type D which is the same as either the first priority TCI state or the second priority TCI state.

Note that in a case where the above (1.1.2d) is satisfied, the UE monitors the CORESET by applying only the TCI state that is of the same QCL type D as the first priority TCI state.

In a case where the above (1.1.2e) is satisfied, the UE monitors the CORESET by applying only the TCI state that is of the same QCL type D as one of the first priority TCI state and the second priority TCI state.

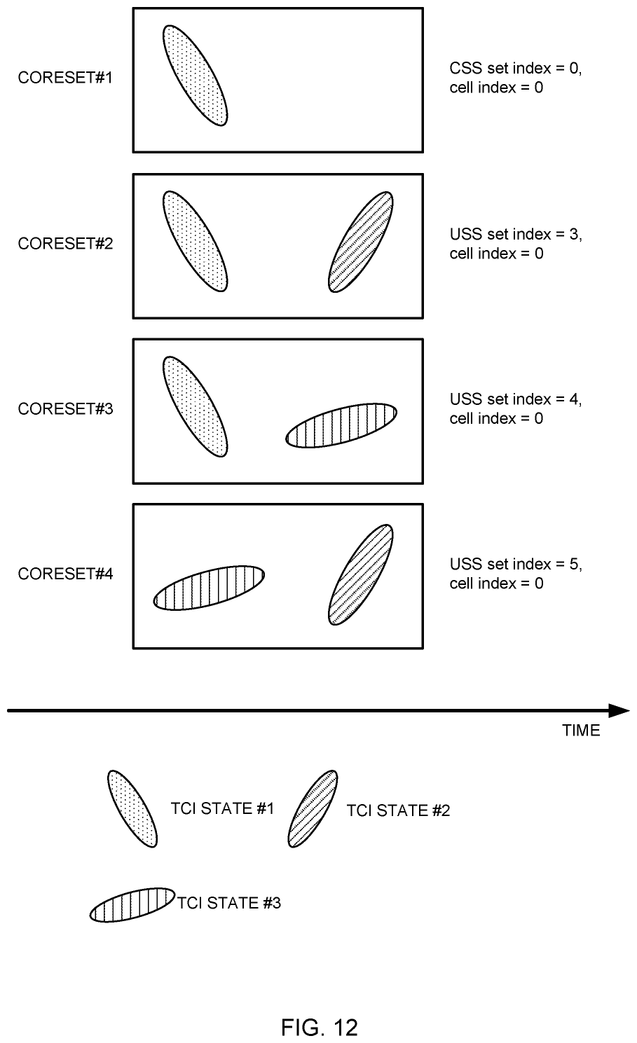

FIG. 12 is a diagram illustrating an example of a prioritized CORESET and another CORESET to be monitored simultaneously in Embodiment 1.1.2. In this example, four CORESETS (CORESETs #1 to #4) overlap in time.

CORESET #1 corresponds to CSS set index=0 and cell index=0, and has one active TCI state (TCI state #1).

CORESET #2 corresponds to USS set index=3 and cell index=0, and has two active TCI states (TCI states #1 and #2).

CORESET #3 corresponds to USS set index=4 and cell index=0, and has two active TCI states (TCI states #1 and #3).

CORESET #4 corresponds to USS set index=5 and cell index=0, and has two active TCI states (TCI states #3 and #2).

In the case of this figure, the UE first selects CORESET #1 corresponding to the CSS set as the prioritized CORESET. Since CORESET #1 has one active TCI state, the operation of Embodiment 1.1.2 is performed. The prioritized CORESET corresponds to the first prioritized CORESET, and TCI state #1 corresponds to the first priority TCI state.

Next, the UE searches for a second prioritized CORESET. Out of the remaining CORESETs #2 to #4, CORESETs that have two active TCI states, and one of the TCI states is the same as the first priority TCI state are CORESETs #2 and #3. The UE determines CORESET #2 with a smaller SS set index as the second prioritized CORESET. The UE determines TCI state #2 different from the first priority TCI state among the TCI states of CORESET #2 as the second priority TCI state, and monitors the PDCCH candidates by applying the TCI states #1 and #2 in CORESET #2.

The UE does not monitor CORESET #3 when considering the condition (1.1.2c). When considering the condition (1.1.2d) or (1.1.2e), the UE monitors CORESET #3 by applying only TCI state #1.

The UE does not monitor CORESET #4 when considering the condition (1.1.2c) or (1.1.2d). The UE monitors CORESET #4 by applying only TCI state #2 when considering the condition (1.1.2e).

### Embodiment 1.2

A priority rule of Embodiment 1.2 is as follows:
Step 1: In a case where there is a subset of CORESETs with two active TCI states among colliding CORESETs, apply a priority rule of Rel. 16 NR only to them. In a case where the prioritized CORESET is found, the step ends. Otherwise, the process proceeds to step 2.
Step 2: In a case where no prioritized CORESET is found in step 1, apply the priority rule of Rel. 16 NR to only a subset of CORESETs with one active TCI state among the colliding CORESETs.

That is, in Embodiment 1.2, the UE determines the prioritized CORESET according to the priority rule that the monitored CORESET is preferentially determined in the order of the CSS set with two active TCI states> the USS set with two active TCI states> the CSS set with one active TCI state> the USS set with one active TCI state.

Note that among SS sets of the same type (CSS or USS) having the same number of active TCI states, the one with a smaller index (that is, the one with a smaller cell index, and in a case where the cell indices are the same, the one with a smaller SS set index) is selected as the prioritized CORESET.

Similarly to the contents described in Embodiment 1.1.1, the CORESET to be monitored may be determined from the CORESET other than the prioritized CORESETs. That is, for a CORESET other than the prioritized CORESETs and having one active TCI state, in a case where the one active TCI state is of QCL type D that is the same as any of the two active TCI states of the prioritized CORESETs, the UE may monitor this CORESET.

Furthermore, for a CORESET other than the prioritized CORESETs and having two active TCI states, the UE may monitor this CORESET when (1.1.1a) or (1.1.1b) described above is satisfied.

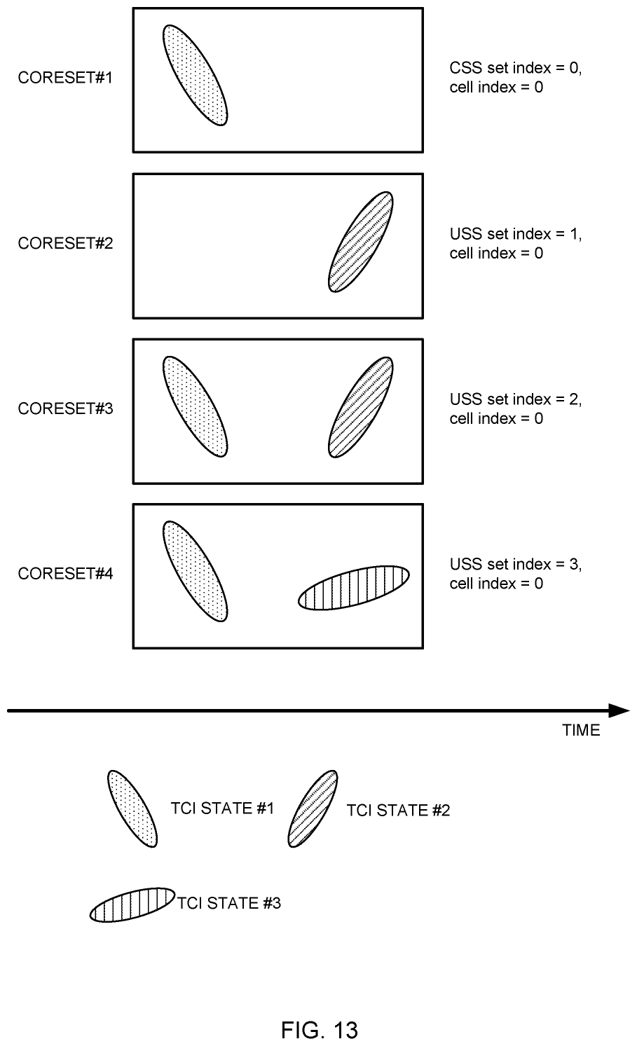

FIG. 13 is a diagram illustrating an example of a prioritized CORESET and another CORESET to be monitored simultaneously in Embodiment 1.2. In this example, four CORESETS (CORESETs #1 to #4) overlap in time.

CORESET #1 corresponds to CSS set index=0 and cell index=0, and has one active TCI state (TCI state #1).

CORESET #2 corresponds to USS set index=1 and cell index=0, and has one active TCI state (TCI state #2).

CORESET #3 corresponds to USS set index=2 and cell index=0, and has two active TCI states (TCI states #1 and #2).

CORESET #4 corresponds to USS set index=3 and cell index=0, and has two active TCI states (TCI states #1 and #3).

In the case of this figure, CORESETs having two active TCI states are CORESETs #3 and #4, and CORESET #3 corresponding to a smaller SS set index is selected as the prioritized CORESET.

Since one TCI state of CORESET #1 is of QCL type D, which is the same as TCI state #1 of the prioritized CORESET, the UE monitors CORESET #1.

Since one TCI state of CORESET #2 is of QCL type D, which is the same as TCI state #2 of the prioritized CORESET, the UE monitors CORESET #2.

One of the two TCI states of CORESET #4 is of the same QCL type D as TCI state #1 of the prioritized CORESET, while the other is of a QCL type D (TCI state #3) different from TCI state #2 of the prioritized CORESET. Therefore, the UE according to (1.1.1a) above does not monitor CORESET #4. The UE according to (1.1.1b) above monitors CORESET #4 by applying only TCI state #1.

### Embodiment 1.3

A priority rule of Embodiment 1.3 is as follows:
Step 1: In a case where there is a CORESET that has two active TCI states among colliding CORESETs and that corresponds to a smallest-index CSS set in a smallest-index cell including the CSS set, determine the CORESET as a prioritized CORESET, and end the step. Otherwise, the process proceeds to step 2.
Step 2: In a case where there is a CORESET that has one active TCI state among the colliding CORESETs and that corresponds to the smallest-index CSS set in the smallest-index cell including the CSS set, determine the CORESET as the prioritized CORESET, and end the step. Otherwise, the process proceeds to step 3.
Step 3: In a case where there is a CORESET that has two active TCI states among the colliding CORESETs and that corresponds to a smallest-index USS set in the smallest-index cell including the USS set, determine the CORESET as the prioritized CORESET, and end the step. Otherwise, the process proceeds to step 4.
Step 4: In a case where there is a CORESET that has one active TCI state among the colliding CORESETs and that corresponds to the smallest-index USS set in the smallest-index cell including the USS set, determine the CORESET as the prioritized CORESET, and end the step.

That is, in Embodiment 1.3, the UE determines the prioritized CORESET according to the priority rule that the monitored CORESET is preferentially determined in the order of the CSS set with two active TCI states> the CSS set with one active TCI state> the USS set with two active TCI states> the USS set with one active TCI state.

Note that among SS sets of the same type (CSS or USS) having the same number of active TCI states, the one with a smaller index (that is, the one with a smaller cell index, and in a case where the cell indices are the same, the one with a smaller SS set index) is selected as the prioritized CORESET.

In a case where the prioritized CORESET is determined in above step 1 or 3, the UE may further determine the CORESET to be monitored from the CORESET other than the prioritized CORESET based on Embodiment 1.1.1.

In a case where the prioritized CORESET is determined in above step 2 or 4, the UE may further determine the CORESET to be monitored from the CORESET other than the prioritized CORESET based on Embodiment 1.1.2.

According to Embodiment A1 described above, it is possible to determine a PDCCH to be appropriately monitored at the time of collision of the plurality of PDCCHS (CORESETs).

### Embodiment A2

Embodiment A2 relates to an FDM PDCCH repetition scheme.

In Embodiment A2, two sets of SSs with corresponding multiple CORESETs may be used for PDCCH repetition. The association between the two SS sets and the plurality of CORESETs may be specified in advance by the specification, or may be set in the UE by higher layer signaling (for example, RRC signaling).

In Embodiment A2, in a case where a plurality of PDCCHs of different QCL type D collide, the UE determines a prioritized CORESET based on at least one priority rule shown in Embodiments 2.1 to 2.3. Each will be described below.

Note that the association between a certain CORESET (for example, prioritized CORESET) and another CORESET may be specified in advance by the specification, or may be set in the UE by higher layer signaling (for example, RRC signaling). Furthermore, the association is not limited to the CORESETs, and CORESETs and SS sets may be associated, or SS sets may be associated.

In Embodiment A2, the prioritized CORESET may be replaced with “prioritized CORESET/SS set corresponding to the prioritized CORESET”. In Embodiment A2, another CORESET may be replaced with “another CORESET/an SS set corresponding to another CORESET”.

The “association” in Embodiment A2 may be referred to as association for collision control of a plurality of PDCCHs, association for CORESET selection of PDCCH monitoring, association related to priority of CORESET, or the like.

### Embodiment 2.1

A priority rule of Embodiment 2.1 is the same as that of Rel. 16 NR. That is, the UE determines the prioritized CORESET according to the priority rule that the CSS set is preferentially monitored over the USS set, and between SS sets of the same type (CSS or USS), an SS set with a smaller index (that is, the one with a smaller cell index, and in a case where the cell indices are the same, the one with a smaller SS set index) is preferentially monitored.

Embodiment 2.1 is further roughly divided into the following two:
Embodiment 2.1.1: A prioritized CORESET is associated with another CORESET.
Embodiment 2.1.2: A prioritized CORESET is not associated with another CORESET.

### Embodiment 2.1.1

The UE may monitor another CORESET related to the prioritized CORESET simultaneously with the prioritized CORESET.

In Embodiment 2.1.1, the TCI state of the prioritized CORESET may be referred to as a first priority TCI state (1st priority TCI state). Furthermore, the TCI state of another CORESET may be referred to as a second priority TCI state (2nd priority TCI state).

For the remaining CORESET except the prioritized CORESET and the another CORESET, the UE may monitor this CORESET in a case where the following condition (2.1.1a) or (2.1.1b) is satisfied:
(2.1.1a) The TCI state is of the same QCL type D as the first priority TCI state.
(2.1.1b) The TCI state is of the same QCL type D as the first priority TCI state or the second priority TCI state.

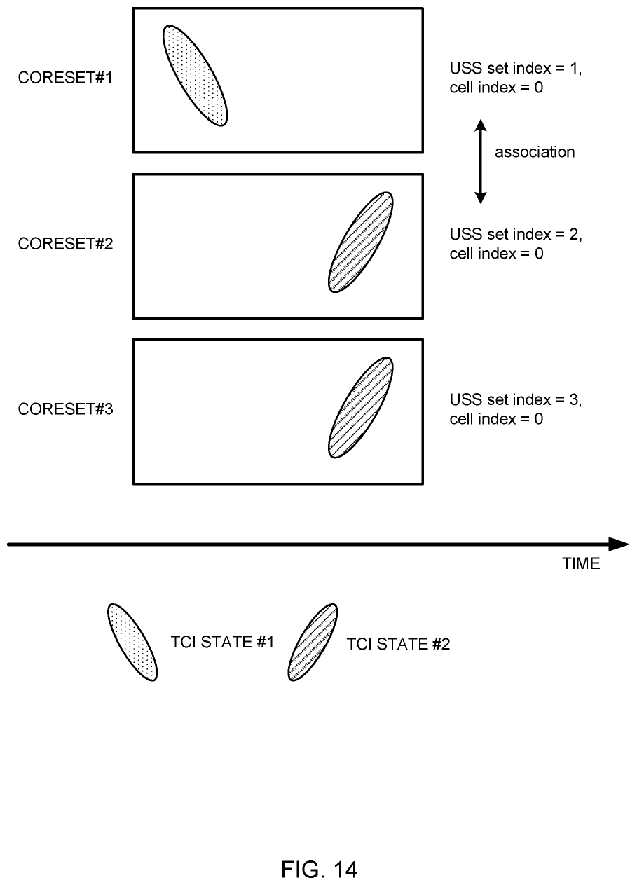

FIG. 14 is a diagram illustrating an example of a prioritized CORESET and another CORESET to be monitored simultaneously in Embodiment 2.1.1. In this example, three CORESETS (CORESETs #1 to #3) overlap in time.

CORESET #1 corresponds to USS set index=1 and cell index=0, and has one active TCI state (TCI state #1).

CORESET #2 corresponds to USS set index=2 and cell index=0, and has one active TCI state (TCI state #2).

CORESET #3 corresponds to USS set index=3 and cell index=0, and has one active TCI state (TCI state #2).

CORESET #1 and CORESET #2 are associated with each other.

In the case of this figure, the UE first selects CORESET #1 corresponding to the USS set with the smallest USS set index as the prioritized CORESET. Since CORESET #1 has another CORESET (CORESET #2) associated therewith, the operation of Embodiment 2.1.1 is performed.

Since CORESET #2 is associated with the prioritized CORESET, the UE monitors CORESET #2. The UE determines the active TCI state of CORESET #2 as the second priority TCI state.

CORESET #3 is not associated with a prioritized CORESET, but the active TCI state for CORESET #3 is of the same QCL type D as the second priority TCI state. Therefore, the UE according to (2.1.1a) above does not monitor CORESET #3. The UE according to (2.1.1b) monitors CORESET #3.

### Embodiment 2.1.2

For Embodiment 2.1.2, the prioritized CORESET first determined according to the same priority rule as Rel. 16 NR is also referred to as a first prioritized CORESET, and the prioritized CORESET other than the first prioritized CORESET determined next is also referred to as a second prioritized CORESET. The second prioritized CORESET may be referred to as CORESET X.

The active TCI state of the first prioritized CORESET may be referred to as a first priority TCI state (1st priority TCI state). The active TCI state of the second prioritized CORESET may be referred to as a second priority TCI state (2nd priority TCI state).

Embodiment 2.1.2 is roughly divided into Embodiments 2.1.2.1 and 2.1.2.2 according to a determination method of the second prioritized CORESET.

### Embodiment 2.1.2.1

The second prioritized CORESET may be determined from remaining colliding CORESETs except the first prioritized CORESET according to a priority rule similar to that of Rel. 16. That is, the second prioritized CORESET may correspond to a smallest-index CSS set in a smallest-index cell including the CSS set, if any, among the remaining colliding CORESETs, or may otherwise correspond to a smallest-index USS set in the smallest-index cell. The smallest USS set index is determined across all USS sets with at least one PDCCH candidate in overlapping PDCCH monitoring opportunities.

In a case where the active TCI state of the candidate for the second prioritized CORESET derived according to the foregoing priority rule is the same as the first priority TCI state, the next candidate (the CORESET corresponding to the SS set/cell with the next smallest index) may be searched as the candidate for the second prioritized CORESET. That is, the UE may continue searching for the second prioritized CORESET until the active TCI state is different from the first priority TCI state.

In a case where a CORESET having only one active TCI state different from the first priority TCI state is found according to the foregoing priority rule, the UE may determine the active TCI state as the second priority TCI state, and determine the CORESET as the second prioritized CORESET.

Note that even in a case where the active TCI state of the candidate for the second prioritized CORESET derived according to the priority rule is the same as the first priority TCI state, the UE may determine the active TCI state as the second priority TCI state and determine the candidate as the second prioritized CORESET. In this case, since the second prioritized CORESET is the same as the first prioritized CORESET, it may be expressed that there is no second prioritized CORESET.

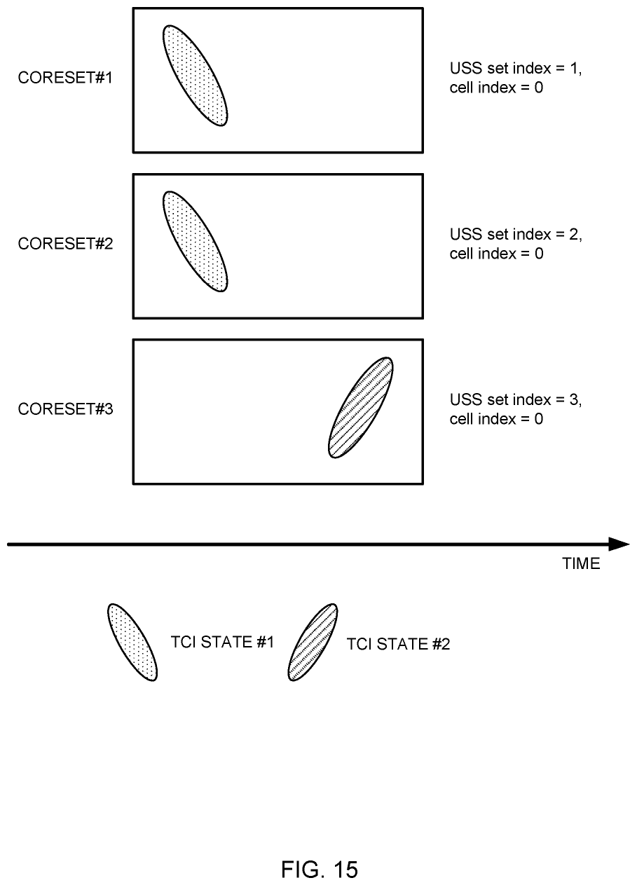

FIG. 15 is a diagram illustrating an example of a prioritized CORESET in Embodiment 2.1.2.1. In this example, three CORESETS (CORESETs #1 to #3) overlap in time.

CORESET #1 corresponds to USS set index=1 and cell index=0, and has one active TCI state (TCI state #1).

CORESET #2 corresponds to USS set index=2 and cell index=0, and has one active TCI state (TCI state #1).

CORESET #3 corresponds to USS set index=3 and cell index=0, and has one active TCI state (TCI state #2).

In the case of this figure, the UE first selects CORESET #1 corresponding to the USS set with the smallest USS set index as the prioritized CORESET. Since CORESET #1 does not have another CORESET associated therewith, the operation of Embodiment 2.1.2 is performed. The prioritized CORESET corresponds to the first prioritized CORESET, and TCI state #1 corresponds to the first priority TCI state.

Next, the UE searches for a second prioritized CORESET. Since the TCI state (TCI state #2) of CORESET #3 is different from TCI state #1 of the prioritized CORESET, the UE determines this TCI state #2 as the second priority TCI state and determines and monitors CORESET #3 as the second prioritized CORESET.

### Embodiment 2.1.2.2

From the remaining colliding CORESETs except the first prioritized CORESET, the UE first determines a subset of CORESETs that are associated with another CORESET and whose TCI state is the same as the first priority TCI state.

Then, the UE may determine the second prioritized CORESET from the subset according to a priority rule similar to Rel. 16. That is, the second prioritized CORESET may correspond to the CSS set with the smallest index in the cell with the smallest index including the CSS set, if any, among the CORESETs included in the subset, or may correspond to the USS set with the smallest index in the cell with the smallest index, if not. The smallest USS set index is determined across all USS sets with at least one PDCCH candidate in overlapping PDCCH monitoring opportunities.

The second priority TCI state may correspond to an active TCI state of another CORESET associated with the second prioritized CORESET.

Note that the second prioritized CORESET may be a CORESET associated with a CORESET corresponding to a smallest-index CSS set in a smallest-index cell including a CSS set if there is any CORESET included in the subset, or may be a CORESET associated with a CORESET corresponding to a smallest-index USS set in the smallest-index cell if there is no CORESET. In this case, the second priority TCI state may correspond to the active TCI state of the second prioritized CORESET.

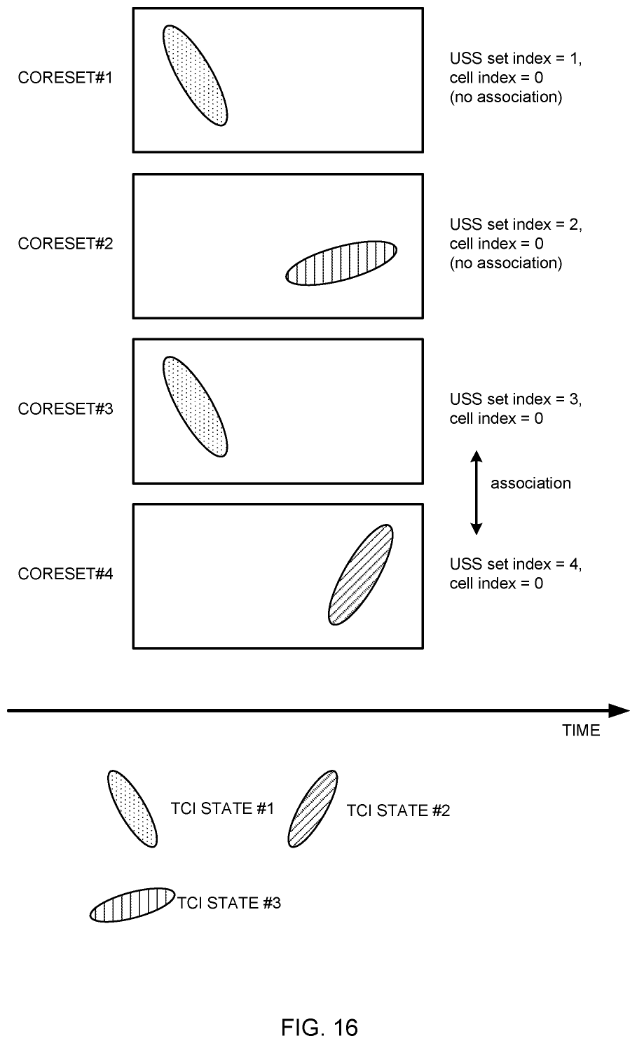

FIG. 16 is a diagram illustrating an example of a prioritized CORESET in Embodiment 2.1.2.2. In this example, four CORESETS (CORESETs #1 to #4) overlap in time.

CORESET #1 corresponds to USS set index=1 and cell index=0, and has one active TCI state (TCI state #1).

CORESET #2 corresponds to USS set index=2 and cell index=0, and has one active TCI state (TCI state #3).

CORESET #3 corresponds to USS set index=3 and cell index=0, and has one active TCI state (TCI state #1).

CORESET #4 corresponds to USS set index=4 and cell index=0, and has one active TCI state (TCI state #2).

CORESET #1 is not associated with any other CORESETs. CORESET #2 is not associated with any other CORESETs. CORESET #3 and CORESET #4 are associated with each other.

In the case of this figure, the UE first selects CORESET #1 corresponding to the USS set with the smallest USS set index as the prioritized CORESET. Since CORESET #1 does not have another CORESET associated therewith, the operation of Embodiment 2.1.2 is performed. The prioritized CORESET corresponds to the first prioritized CORESET, and TCI state #1 corresponds to the first priority TCI state.

Next, the UE searches for a second prioritized CORESET. Among the remaining CORESETs #2 to #4, only CORESET #3 has another associated CORESET, and has a TCI state same as the first priority TCI state. Therefore, the UE determines CORESET #3 as the second prioritized CORESET, and determines TCI state #2 of CORESET #4 associated with CORESET #3 as the second priority TCI state. The UE monitors the PDCCH candidates in CORESETs #3 and #4.

### CORESET Other Than Prioritized CORESET

Monitoring of prioritized CORESETs (first prioritized CORESET and second prioritized CORESET) and a CORESET other than CORESETs associated with the prioritized CORESETs in Embodiment 2.1.2 will be described.

For these CORESETs, the UE may monitor the CORESETs in a case where the following condition (2.1.2a) or (2.1.2b) is met:
(2.1.2a) The TCI state is of the same QCL type D as the first priority TCI state.
(2.1.2b) The TCI state is of the same QCL type D as the first priority TCI state or the second priority TCI state.

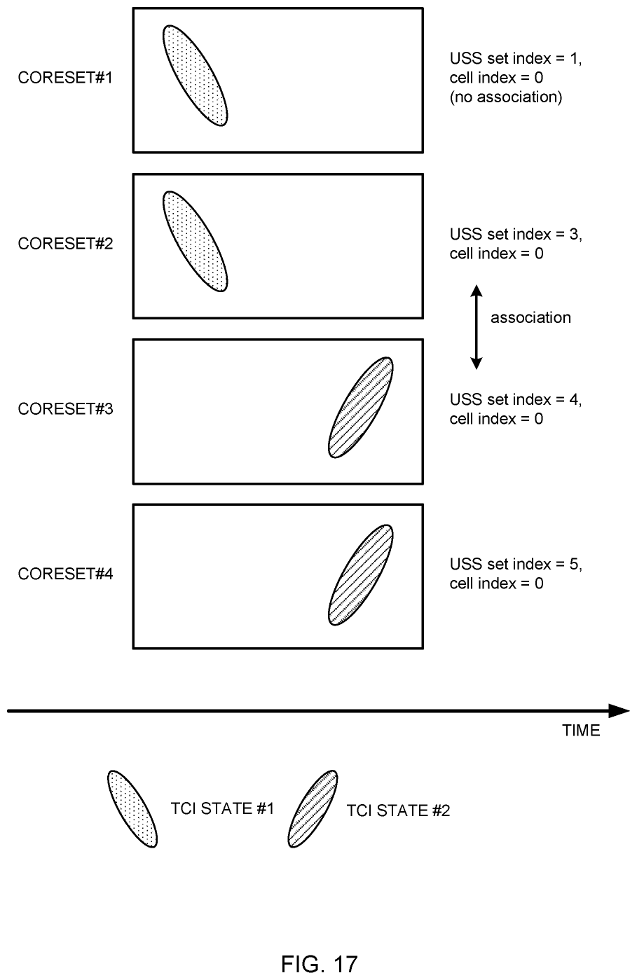

FIG. 17 is a diagram illustrating an example of a prioritized CORESET and another CORESET to be monitored simultaneously in Embodiment 2.1.2. In this example, four CORESETS (CORESETs #1 to #4) overlap in time.

CORESET #1 corresponds to USS set index=1 and cell index=0, and has one active TCI state (TCI state #1).

CORESET #2 corresponds to USS set index=3 and cell index=0, and has one active TCI state (TCI state #1).

CORESET #3 corresponds to USS set index=4 and cell index=0, and has one active TCI state (TCI state #2).

CORESET #4 corresponds to USS set index=5 and cell index=0, and has one active TCI state (TCI state #2).

CORESET #1 is not associated with any other CORESETs. CORESET #2 and CORESET #3 are associated with each other.

In the case of this figure, the UE first selects CORESET #1 corresponding to the USS set with the smallest USS set index as the prioritized CORESET. Since CORESET #1 does not have another CORESET associated therewith, the operation of Embodiment 2.1.2 is performed. The prioritized CORESET corresponds to the first prioritized CORESET, and TCI state #1 corresponds to the first priority TCI state.

Next, the UE searches for a second prioritized CORESET. Among the remaining CORESETs #2 to #4, only CORESET #2 has another associated CORESET, and has a TCI state same as the first priority TCI state. Therefore, the UE determines CORESET #2 as the second prioritized CORESET, and determines TCI state #2 of CORESET #3 associated with CORESET #2 as the second priority TCI state. The UE monitors the PDCCH candidates in CORESETs #2 and #3.

The UE does not monitor CORESET #4 when considering the condition (2.1.2a). The UE monitors CORESET #4 when considering the condition (2.1.2b).

### Embodiment 2.2

A priority rule of Embodiment 2.2 is as follows:
Step 1: In a case where there is a subset of (In other words, it has an association with another CORESET.) CORESETs associated with another CORESET among colliding CORESETs, apply a priority rule of Rel. 16 NR only to them. In a case where the prioritized CORESET is found, the step ends. Otherwise, the process proceeds to step 2.
Step 2: In a case where no prioritized CORESET is found in step 1, apply the priority rule of Rel. 16 NR only to a subset of CORESETs that do not have an association with another CORESET among the colliding CORESETs.

That is, in Embodiment 2.2, the UE determines the prioritized CORESET according to the priority rule that the CORESET to be monitored is preferentially determined in the order of a CSS set having an association (Hereinafter, in the present disclosure, it is also simply referred to as “association”.) with another CORESET> a USS set having the association> a CSS set having no association> a USS set having no association.

Note that among SS sets of the same type (CSS or USS) that have (or do not have) the association, the one with a smaller index (that is, the one with a smaller cell index, and in a case where the cell indices are the same, the one with a smaller SS set index) is selected as the priority CORESET.

Similarly to the contents described in Embodiment 2.1.1, the CORESET to be monitored may be determined from the CORESET other than the prioritized CORESETs. That is, for the remaining CORESET excluding the prioritized CORESETs and another CORESET associated with the prioritized CORESETs, the UE may monitor this CORESET when (2.1.1a) or (2.1.1b) described above is satisfied.

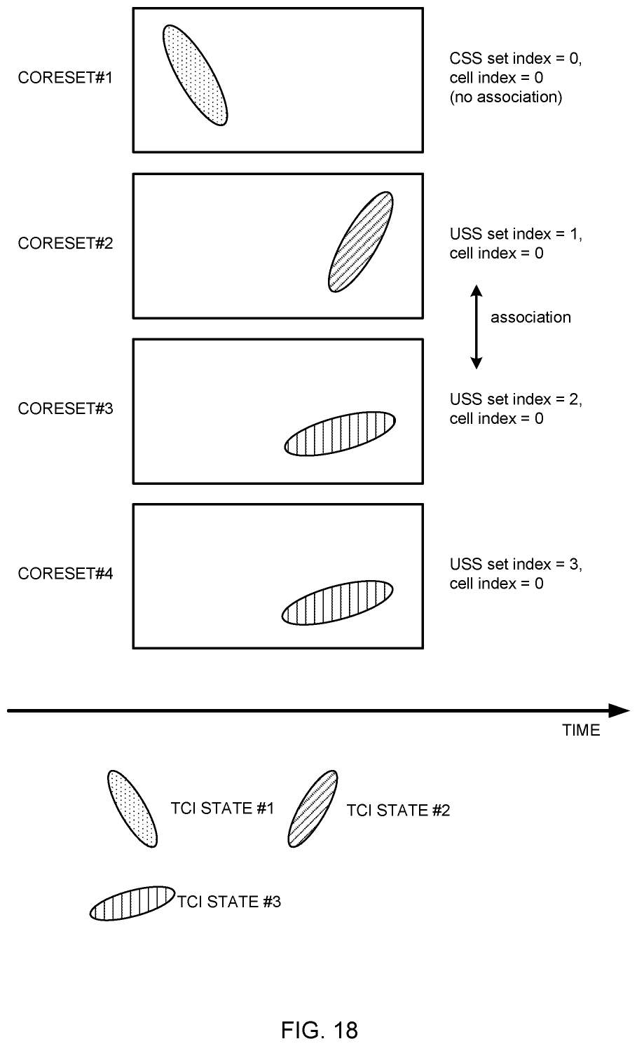

FIG. 18 is a diagram illustrating an example of a prioritized CORESET and another CORESET to be monitored simultaneously in Embodiment 2.2. In this example, four CORESETS (CORESETs #1 to #4) overlap in time.

CORESET #1 corresponds to CSS set index=0 and cell index=0, and has one active TCI state (TCI state #1).

CORESET #2 corresponds to USS set index=1 and cell index=0, and has one active TCI state (TCI state #2).

CORESET #3 corresponds to USS set index=2 and cell index=0, and has one active TCI state (TCI state #3).

CORESET #4 corresponds to USS set index=3 and cell index=0, and has one active TCI state (TCI state #3).

CORESET #1 is not associated with any other CORESETs. CORESET #2 and CORESET #3 are associated with each other.

In the case of this figure, CORESETs associated with another CORESET are CORESETs #2 and #3, and CORESET #2 corresponding to a smaller SS set index is selected as the prioritized CORESET. TCI state #2 of CORESET #2 corresponds to the first priority TCI state.

TCI state #3 of CORESET #3 associated with the prioritized CORESET is determined as the second priority TCI state. The UE monitors the PDCCH candidates in CORESETs #2 and #3.

Since the TCI state of CORESET #1 is neither the first priority TCI state nor the second TCI state, the UE does not monitor CORESET #1. Furthermore, the UE according to (2.1.1a) above does not monitor CORESET #4. The UE according to (2.1.1b) monitors CORESET #4.

### Embodiment 2.3

A priority rule of Embodiment 2.3 is as follows:
Step 1: In a case where there is a CORESET that has the association among colliding CORESETs and that corresponds to a smallest-index CSS set in a smallest-index cell including a CSS set, determine the CORESET as a prioritized CORESET, and end the step. Otherwise, the process proceeds to step 2.
Step 2: In a case where there is a CORESET that has no association among the colliding CORESETs and that corresponds to the smallest-index CSS set in the smallest-index cell including the CSS set, determine the CORESET as the prioritized CORESET, and end the step. Otherwise, the process proceeds to step 3.
Step 3: In a case where there is a CORESET that has the association among the colliding CORESETs and that corresponds to a smallest-index USS set in the smallest-index cell including a USS set, determine the CORESET as the prioritized CORESET, and end the step. Otherwise, the process proceeds to step 4.
Step 4: In a case where there is a CORESET that has no association among the colliding CORESETs and that corresponds to the smallest-index USS set in the smallest-index cell including the USS set, the CORESET is determined as the prioritized CORESET, and the step ends.

That is, in Embodiment 2.3, the UE determines the prioritized CORESET according to the priority rule that the CORESET to be monitored is preferentially determined in the order of a CSS set with the association> a CSS set with no association> a USS set with the association> a USS set with no association.

Note that among SS sets of the same type (CSS or USS) that have (or do not have) the association, the one with a smaller index (that is, the one with a smaller cell index, and in a case where the cell indices are the same, the one with a smaller SS set index) is selected as the priority CORESET.

In a case where the prioritized CORESET is determined in the above step 1 or 3, the UE may further determine the CORESET to be monitored from the CORESET other than the prioritized CORESET based on Embodiment 2.1.1.

In a case where the prioritized CORESET is determined in the above step 2 or 4, the UE may further determine the CORESET to be monitored from the CORESET other than the prioritized CORESET based on Embodiment 2.1.2.

According to Embodiment A2 described above, it is possible to determine a PDCCH to be appropriately monitored at the time of collision of the plurality of PDCCHS (CORESETs).

### <Others>

Note that at least one of the above-described embodiments may be applied only to a UE that has reported a specific UE capability or supports the specific UE capability.

The particular UE capability may indicate at least one of the following:
whether or not to support an SFN PDCCH repetition scheme;
whether or not to support an FDM PDCCH repetition scheme;
whether or not to support an SFN PDCCH repetition scheme for a CSS set;
whether or not to support an FDM PDCCH repetition scheme for a CSS set; and
whether or not to support simultaneous reception of two or more different QCL Type D PDCCHs.

Furthermore, at least one of the foregoing embodiments may be applied when the UE sets specific information related to the foregoing embodiments by higher layer signaling (If not set, for example, the operation of Rel. 15/16 is applied.). For example, the specific information may be information indicating that the SFN/FDM PDCCH repetition scheme is activated, any RRC parameter for a specific release (for example, Rel. 17), or the like.

Note that Embodiment A1 is not limited to a case where the UE configures (or uses) the SFN PDCCH repetition scheme, and is applicable to a case where two or more TCI states are activated for one CORESET.

Furthermore, Embodiment A2 is not limited to a case in which the UE sets (or utilizes) the FDM PDCCH repetition scheme, and is applicable to a case in which two SS sets having a plurality of corresponding CORESETs are used for the PDCCH.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

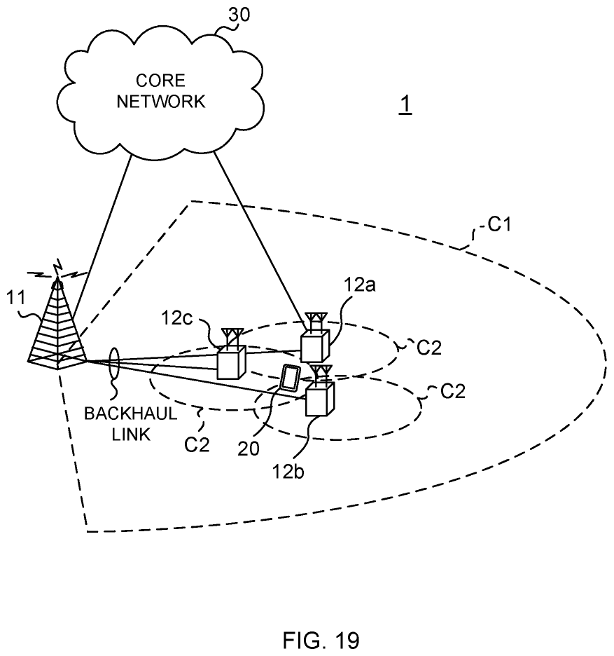

FIG. 19 is a diagram illustrating an example of a schematic configuration of the radio communication system according to the embodiment. A radio communication system 1 may be a system that implements communication using long term evolution (LTE), 5th generation mobile communication system New Radio (5G NR), and the like drafted as the specification by third generation partnership project (3GPP).

Furthermore, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is the MN, and an LTE (E-UTRA) base station (eNB) is the SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The allocation, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a frequency range 1 (FR1) or a second frequency range 2 (FR2). The macro cell C1 may be included in FR1, and the small cell C2 may be included in FR2. For example, FR1 may be a frequency range of 6 GHz or less (sub-6 GHZ), and FR2 may be a frequency range higher than 24 GHZ (above-24 GHZ). Note that the frequency bands, definitions, and the like of the FR1 and FR2 are not limited thereto, and, for example, the FR1 may correspond to a frequency band higher than the FR2.

Furthermore, the user terminal 20 may perform communication in each CC using at least one of time division duplex (TDD) or frequency division duplex (FDD).

The plurality of base stations 10 may be connected by wire (e.g., an optical fiber or an X2 interface in compliance with common public radio interface (CPRI)) or wirelessly (e.g., NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), or a next generation core (NGC).

The user terminal 20 may a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Furthermore, in the radio communication system 1, as an uplink channel, a physical uplink shared channel (PUSCH), a physical uplink control channel (PUCCH), a physical random access channel (PRACH), or the like shared by the user terminals 20 may be used.

User data, higher layer control information, a system information block (SIB), and the like are transmitted on the PDSCH. The PUSCH may transmit the user data, higher layer control information, and the like. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that the DCI that schedules the PDSCH may be referred to as DL assignment, DL DCI, or the like, and the DCI that schedules PUSCH may be referred to as UL grant, UL DCI, or the like. Note that the PDSCH may be replaced with DL data, and the PUSCH may be replaced with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space based on search space configuration.

One search space may correspond to a PDCCH candidate corresponding to one or more aggregation levels. One or more search spaces may be referred to as a search space set. Note that “search space” and “search space set”, “search space configuration” and “search space set configuration”, and “CORESET” and “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). Note that, DMRSs may be referred to as “user terminal-specific reference signals (UE-specific Reference Signals).”

### (Base Station)

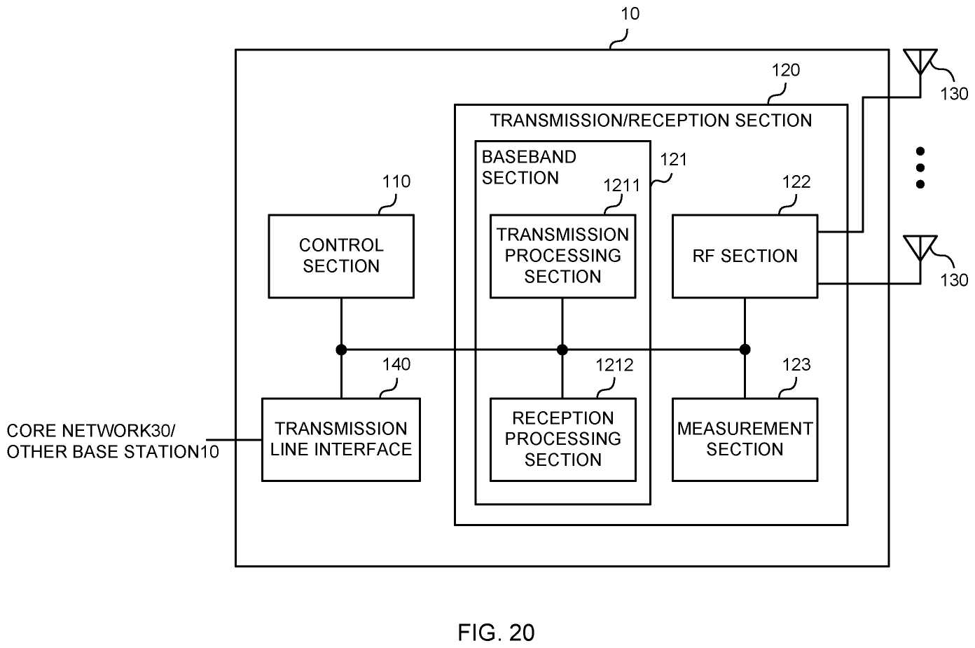

FIG. 20 is a diagram illustrating an example of a configuration of a base station according to an embodiment. The base station 10 includes a control section 110, a transmission/reception section 120, a transmission/reception antenna 130, and a transmission line interface 140. Note that one or more control sections 110, one or more transmission/reception sections 120, one or more transmission/reception antennas 130, and one or more transmission line interfaces 140 may be included.

Note that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be implemented by a controller, a control circuit, and the like that are described based on common recognition in the technical field related to the present disclosure.

The control section 110 may control signal generation, scheduling (for example, resource allocation or mapping), and the like. The control section 110 may control transmission/reception, measurement, and the like using the transmission/reception section 120, the transmission/reception antenna 130, and the transmission line interface 140. The control section 110 may generate data to be transmitted as a signal, control information, a sequence, and the like, and may forward the data, the control information, the sequence, and the like to the transmission/reception section 120. The control section 110 may perform call processing (such as configuration or releasing) of a communication channel, management of the state of the base station 10, and management of a radio resource.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can include a transmission section/reception section, an RF circuit, a baseband circuit, a filter, a phase shifter, a measurement circuit, a transmission/reception circuit, and the like that are described on the basis of common recognition in the technical field related to the present disclosure.

The transmission/reception section 120 may be configured as an integrated transmission/reception section, or may be configured by a transmission section and a reception section. The transmission section may include the transmission processing section 1211 and the RF section 122. The reception section may be implemented by the reception processing section 1212, the RF section 122, and the measurement section 123.

The transmission/reception antennas 130 can be implemented by antennas described based on common recognition in the technical field related to the present disclosure, for example, an array antenna.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a transmission beam or a reception beam by using digital beam forming (for example, precoding), analog beam forming (for example, phase rotation), and the like.

The transmission/reception section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmission/reception section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmission/reception section 120 (RF section 122) may perform modulation to a radio frequency band, filtering processing, amplification, and the like on the baseband signal, and may transmit a signal in the radio frequency band via the transmission/reception antenna 130.

Meanwhile, the transmission/reception section 120 (RF section 122) may perform amplification, filtering processing, demodulation to a baseband signal, and the like on the signal in the radio frequency band received by the transmission/reception antenna 130.

The transmission/reception section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmission/reception section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

Note that the transmission section and the reception section of the base station 10 in the present disclosure may include at least one of the transmission/reception section 120, the transmission/reception antenna 130, or the transmission line interface 140.

The control section 110 may determine a plurality of targets to be monitored from a plurality of candidates that are any one of a search space set, a physical downlink control channel (PDCCH) candidate, and a control resource set. The transmission/reception section 120 may transmit the PDCCH in any of the plurality of targets. The control section 110 may preferentially include, in the plurality of targets, a first candidate having linkage with another candidate among the plurality of candidates and a second candidate corresponding to a common search space set.

### (User Terminal)

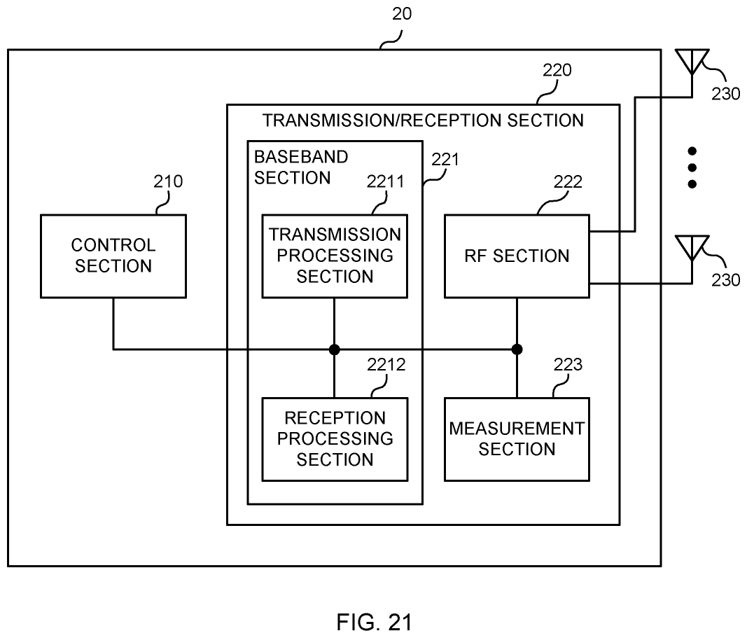

FIG. 21 is a diagram illustrating an example of a configuration of a user terminal according to one embodiment. The user terminal 20 includes a control section 210, a transmission/reception section 220, and a transmission/reception antenna 230. Note that one or more of the control sections 210, one or more of the transmission/reception sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmission/reception section 220 and the transmission/reception antenna 230. The control section 210 may generate data, control information, a sequence, and the like to be transmitted as signals, and may forward the data, control information, sequence, and the like to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can be implemented by a transmitter/receiver, an RF circuit, a baseband circuit, a filter, a phase shifter, a measurement circuit, a transmission/reception circuit, and the like that are described based on common recognition in the technical field related to the present disclosure.

The transmission/reception section 220 may be formed as an integrated transmission/reception section, or may include a transmission section and a reception section. The transmission section may include the transmission processing section 2211 and the RF section 222. The reception section may include the reception processing section 2212, the RF section 222, and the measurement section 223.

The transmission/reception antenna 230 can include an antenna described on the basis of common recognition in the technical field related to the present disclosure, for example, an array antenna.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a transmission beam or a reception beam by using digital beam forming (for example, precoding), analog beam forming (for example, phase rotation), and the like.

The transmission/reception section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmission/reception section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. In a case where transform precoding is enabled for a certain channel (e.g., PUSCH), the transmission/reception section 220 (transmission processing section 2211) may perform DFT processing as the transmission processing in order to transmit the channel using a DFT-s-OFDM waveform. In a case where it is not the case, DFT processing need not be performed as the transmission processing.

The transmission/reception section 220 (RF section 222) may perform modulation to a radio frequency range, filtering processing, amplification, and the like on the baseband signal, to transmit a signal in the radio frequency range via the transmission/reception antenna 230.

Meanwhile, the transmission/reception section 220 (RF section 222) may perform amplification, filtering processing, demodulation to a baseband signal, and the like on the signal in the radio frequency range received by the transmission/reception antenna 230.

The transmission/reception section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmission/reception section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmission section and the reception section of the user terminal 20 in the present disclosure may include at least one of the transmission/reception section 220 or the transmission/reception antenna 230.

The control section 210 may determine a plurality of targets to be monitored from a plurality of candidates that are any one of a search space set, a physical downlink control channel (PDCCH) candidate, and a control resource set. The transmission/reception section 220 may monitor the plurality of targets. The control section 210 may preferentially include, in the plurality of targets, a first candidate having linkage with another candidate among the plurality of candidates and a second candidate corresponding to a common search space set.

The control section 210 may give priority to the first candidate and then give priority to the second candidate (first embodiment).

The control section 210 may give priority to the second candidate, and then give priority to the first candidate (second embodiment).

The first candidate and the other candidate may be in the same slot or the same span.

### (Hardware Configuration)

Note that the block diagrams that have been used to describe the above embodiments illustrate blocks in functional units. These functional blocks (components) may be implemented in arbitrary combinations of at least one of hardware or software. Furthermore, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be realized by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmission section (transmitting unit), a transmitter, and the like. In any case, as described above, the implementation method is not particularly limited.

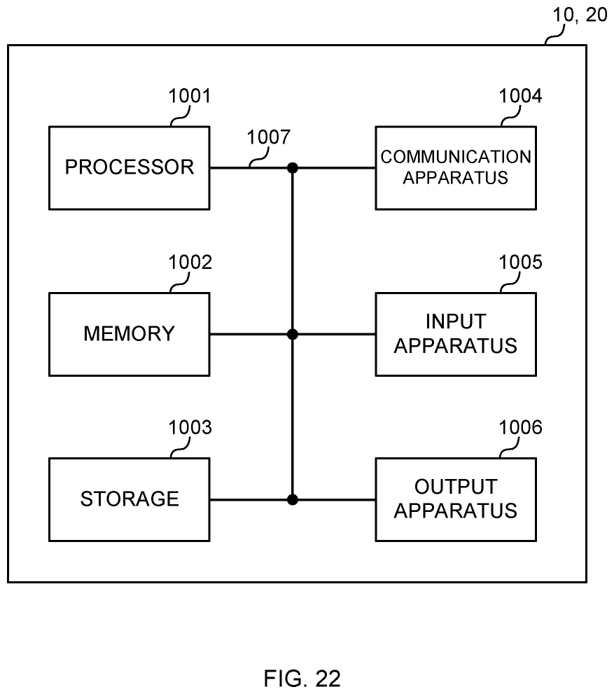

For example, the base station, the user terminal, and the like according to one embodiment of the present disclosure may function as a computer that executes the processing of the radio communication method of the present disclosure. FIG. 22 is a diagram illustrating an example of a hardware configuration of the base station and the user terminal according to an embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be designed to include one or more of the apparatuses illustrated in the drawings, or may be designed not to include some apparatuses.

For example, although only one processor 1001 is shown, a plurality of processors may be provided. Furthermore, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by given software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least a part of the above-described control section 110 (210), transmission/reception section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network or a radio network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmission/reception section 120 (220), the transmission/reception antenna 130 (230), and the like described above may be implemented by the communication apparatus 1004. The transmission/reception section 120 (220) may be implemented by being physically or logically separated into the transmission section 120a (220a) and the reception section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus (these apparatus), including the processor 1001, the memory 1002 and so on are connected by the bus 1007 so as to communicate information. The bus 1007 may be formed with a single bus, or may be formed with buses that vary between pieces of apparatus (between apparatus).

Furthermore, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware (these hardware).

### Modified Example

Note that terms described in the present disclosure and terms necessary for understanding the present disclosure may be replaced with terms that have the same or similar meanings. For example, a channel, a symbol, and a signal (signal or signaling) may be replaced with each other. Furthermore, the signal may be a message. The reference signal can be abbreviated as an RS, and may be referred to as a pilot, a pilot signal, and the like, depending on which standard applies. Furthermore, a component carrier (CC) may be referred to as a cell, a frequency carrier, a carrier frequency, and the like.

A radio frame may be comprised of one or more periods (frames) in the time domain. Each of the one or more periods (frames) included in the radio frame may be referred to as a subframe. Moreover, the subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. Furthermore, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a minislot and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit of a channel-coded data packet (transport block), a code block, a codeword, etc. or may be a processing unit of scheduling, link adaptation, etc. When the TTI is given, a time interval (e.g., the number of symbols) to which a transport block, a code block, a codeword, or the like is actually mapped may be shorter than the TTI.

Note that, when one slot or one minislot is referred to as a “TTI,” one or more TTIs (that is, one or multiple slots or one or more minislots) may be the minimum time unit of scheduling. Also, the number of slots (the number of minislots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

Also, an RB may include one or more symbols in the time domain, and may be one slot, one minislot, one subframe or one TTI in length. One TTI, one subframe, etc. may each be comprised of one or more resource blocks.

Note that one or more RBs may be referred to as a physical resource block (PRB), a subcarrier group (SCG), a resource element group (REG), a PRB pair, an RB pair, and

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to expect transmission/reception of a given signal/channel outside the active BWP. Note that “cell”, “carrier”, etc. in the present disclosure may be replaced with “BWP”.

Note that the structures of radio frames, subframes, slots, minislots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to given values, or may be represented using other corresponding information. For example, a radio resource may be specified by a given index.

The names used for parameters etc. in the present disclosure are in no respect limiting. Moreover, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Information, signals, etc. can be output in at least one of a direction from a higher layer to a lower layer or a direction from a lower layer to a higher layer. Information, signals and so on may be input and output via a plurality of network nodes.

The information, signals and so on that are input and/or output may be stored in a specific location (for example, in a memory), or may be managed in a control table. The information, signals, and the like to be input and output can be overwritten, updated, or appended. The output information, signals, and the like may be deleted. The information, signals and so on that are input may be transmitted to other pieces of apparatus (other apparatus).

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Furthermore, the RRC signaling may be referred to as an RRC message, and may be, for example, an RRC connection setup message, an RRC connection reconfiguration message, and the like. Furthermore, notification of the MAC signaling may be performed using, for example, an MAC control element (CE).

Also, reporting of given information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, mobile unit, subscriber station, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or the mobile station may be called as a transmission device, a reception device, a radio communication device, and the like. Note that at least one of the base station or the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IOT) device such as a sensor.

Furthermore, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Furthermore, words such as “uplink” and “downlink” may be replaced with words corresponding to terminal-to-terminal communication (for example, “sidelink”). For example, the uplink channel, the downlink channel, and the like may be replaced with a sidelink channel.

Likewise, a user terminal in the present disclosure may be replaced with a base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Furthermore, the order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Furthermore, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on.”

All references to the elements using designations such as “first” and “second” as used in the present disclosure do not generally limit the amount or sequence of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

Furthermore, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

Furthermore, “determining” may be replaced with “assuming”, “expecting”, “considering”, or the like.

The “maximum transmission power” described in the present disclosure may mean a maximum value of transmission power, nominal UE maximum transmit power, or rated UE maximum transmit power.

The terms “connected” and “coupled” used in the present disclosure, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or

In the present disclosure, the terms “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Moreover, the term “or” used in the present disclosure is intended to be not an exclusive-OR.

In the present disclosure, when articles are added by translation, for example, as “a”, “an”, and “the” in English, the present disclosure may include that nouns that follow these articles are plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

The present application is based on Japanese Patent Application No. 2021-070114 filed on Apr. 19, 2021. The contents of this are all incorporated herein.

1. A terminal comprising:
a control section that determines a plurality of targets to be monitored from a plurality of candidates that are any of a search space set, a physical downlink control channel (PDCCH) candidate, and a control resource set; and
a reception section that monitors the plurality of targets,
wherein the control section preferentially includes, in the plurality of targets, a first candidate having a linkage with another candidate among the plurality of candidates and a second candidate corresponding to a common search space set.

2. The terminal according to claim 1, wherein the control section gives priority to the first candidate and then gives priority to the second candidate.

3. The terminal according to claim 1, wherein the control section gives priority to the second candidate and then gives priority to the first candidate.

4. The terminal according to claim 1, wherein the first candidate and the other candidate are in a same slot or in a same span.

5. A radio communication method of a terminal, the method comprising:
determining a plurality of targets to be monitored from a plurality of candidates that are any of a search space set, a physical downlink control channel (PDCCH) candidate, and a control resource set; and
monitoring the plurality of targets,
wherein the terminal preferentially includes, in the plurality of targets, a first candidate having a linkage with another candidate among the plurality of candidates and a second candidate corresponding to a common search space set.

6. A base station comprising:
a control section that determines a plurality of targets to be monitored from a plurality of candidates that are any of a search space set, a physical downlink control channel (PDCCH) candidate, and a control resource set; and
a transmission section that transmits a PDCCH in any of the plurality of targets,
wherein the control section preferentially includes, in the plurality of targets, a first candidate having a linkage with another candidate among the plurality of candidates and a second candidate corresponding to a common search space set.

7. The terminal according to claim 2, wherein the first candidate and the other candidate are in a same slot or in a same span.

8. The terminal according to claim 3, wherein the first candidate and the other candidate are in a same slot or in a same span.
